(19) United States
(12) Patent Application Publication
(10) Pub. No.: US 2025/0284188 A1
(43) Pub. Date: Sep. 11, 2025

(54) PROJECTOR

(71) Applicant: SEIKO EPSON CORPORATION, Tokyo (JP)

(72) Inventors: Kiyomi SATO, MATSUMOTO-SHI (JP); Takeshi SOWA, MATSUMOTO-SHI (JP)

(21) Appl. No.: 19/076,067

(22) Filed: Mar. 11, 2025

(30) Foreign Application Priority Data
Mar. 11, 2024 (JP) 2024-037568

(51) Int. Cl. G03B 21/20; G03B 21/28

(52) U.S. Cl. CPC G03B 21/208; G03B 21/2013; G03B 21/28

(57) ABSTRACT

A projector according to an embodiment of the present disclosure includes a first light source including a first light emitting device configured to emit first light having a first wavelength band, a first electrically conducting line configured to supply the first light emitting device with electric power, and a base configured to support the first light emitting device and the first electrically conducting line; a first light guide having a first light incident end on which the first light output from the first light source is incident and a first light exiting end via which the first light exits, the first light guide configured to homogenize in-plane illuminance of the first light; a first parallelizing element configured to parallelize the first light output from the first light guide; a first light modulator configured to modulate the first light output from the first parallelizing element based on image information; and a projection system configured to project the light modulated by the first light modulator. The first light guide is disposed away from the first electrically conducting line, and a first distance between the first light incident end of the first light guide and the first light source is smaller than or equal to 0.7 mm.

The present application is based on, and claims priority from JP Application Serial Number 2024-037568, filed Mar. 11, 2024, the disclosure of which is hereby incorporated by reference herein in its entirety.

### BACKGROUND

### 1. Technical Field

The present disclosure relates to a projector.

### 2. Related Art

There is a known projector including a light source that outputs color light, a light modulation apparatus that modulates the color light output from the light source in accordance with image information to generate image light, and a projection system that enlarges the image light output from the light modulation apparatus and projects the enlarged image light onto a projection receiving surface such as a screen. The projector includes a light source apparatus including, for example, a blue light source that outputs blue light, an excitation light source that is provided separately from the blue light source and outputs blue light, and a phosphor that is excited by the blue light output from the excitation light source to emit yellow light. In the thus configured projector, white light containing the blue light and the yellow light is output from the light source apparatus, and the multiple types of color light contained in the white light are converted into multiple types of image light by a common light modulation apparatus or light modulation apparatuses disposed on a color light basis.

For example, JP-A-10-361256 discloses a projector using multiple light emitting diodes (LEDs) as light emitting devices in light sources. In a projector disclosed in JP-A-10-361256, multiple types of color light emitted from the LEDs pass through blocks, are then superimposed on a path extending in one direction, modulated by a light modulator, and enlarged and projected by a projection lens. The blocks each have a parabolic side surface, and cause the angular distribution of the color light that exits via the light exiting end surface of the block to fall within a range from 0° to 90°. The multiple types of color light output from the multiple blocks enter a dichroic prism disposed to superimpose the multiple types of light from the multiple LEDs on one another.

JP-A-10-361256 is an example of the related art.

In general, a light emitting device such as an LED is mounted on a support member such as a substrate, and is coupled by wire bonding to an electrode such as a lead frame or a pad formed at the support member separately from the light emitting device. In the technology disclosed in JP-A-10-361256, in which the light sources and the blocks are in intimate contact with each other, so that the wires that couple the light emitting device to the electrode in any of the light sources as described above are in direct contact with the block, conceivably resulting in a short circuit or disconnection of the wires. It is conceivable in this case to address the problem by employing a configuration in which the light sources and the blocks are arranged separately from each other. However, depending on the distance between the light sources and the blocks, the efficiency at which the multiple types of light output from the light sources are introduced into the blocks decreases, possibly resulting in insufficient efficiency at which the light is used in the projector. That is, it is required to provide a projector capable of preventing disconnection of wires that couple a light emitting device in a light source to an electrode or a short circuit in the light source while suppressing a decrease in light use efficiency.

### SUMMARY

A projector according to an aspect of the present disclosure includes a first light source including a first light emitting device configured to emit first light having a first wavelength band, a first electrically conducting line configured to supply the first light emitting device with electric power, and a base configured to support the first light emitting device and the first electrically conducting line; a first light guide having a first light incident end on which the first light output from the first light source is incident and a first light exiting end via which the first light exits, the first light guide configured to homogenize in-plane illuminance of the first light; a first parallelizing element configured to parallelize the first light output from the first light guide; a first light modulator configured to modulate the first light output from the first parallelizing element based on image information; and a projection system configured to project the light modulated by the first light modulator. The first light guide is disposed away from the first electrically conducting line, and a first distance between the first light incident end of the first light guide and the first light source is smaller than or equal to 0.7 mm.

### BRIEF DESCRIPTION OF THE DRAWINGS

FIG. 1 is a schematic diagram showing the configuration of a projector according to an embodiment.

FIG. 2 is a side view of a blue light outputting section of the projector shown in FIG. 1.

FIG. 3 is a plan view of the blue light outputting section of the projector shown in FIG. 1.

FIG. 4 is a side view of a green light outputting section of the projector shown in FIG. 1.

FIG. 5 is a side view of a red light outputting section of the projector shown in FIG. 1.

FIG. 6 is a side view of a blue light outputting section in a first variation of the projector shown in FIG. 1.

FIG. 7 is another side view of the blue light outputting section in the first variation of the projector shown in FIG. 1.

FIG. 8 is a side view of a green light outputting section in a second variation of the projector shown in FIG. 1.

FIG. 9 is a plan view of the green light outputting section in the second variation of the projector shown in FIG. 1.

FIG. 10 is a side view of a blue light outputting section in a third variation of the projector shown in FIG. 1.

FIG. 11 is a side view of a blue light outputting section in a fourth variation of the projector shown in FIG. 1.

FIG. 12 is a plan view of the blue light outputting section in the fourth variation of the projector shown in FIG. 1.

FIG. 13 is a side view of a blue light outputting section in a fifth variation of the projector shown in FIG. 1.

### DESCRIPTION OF EMBODIMENTS

An embodiment of the present disclosure will be described below with reference to the drawings. In the drawings, elements are drawn at different dimensional scales in some cases for clarity of each of the elements.

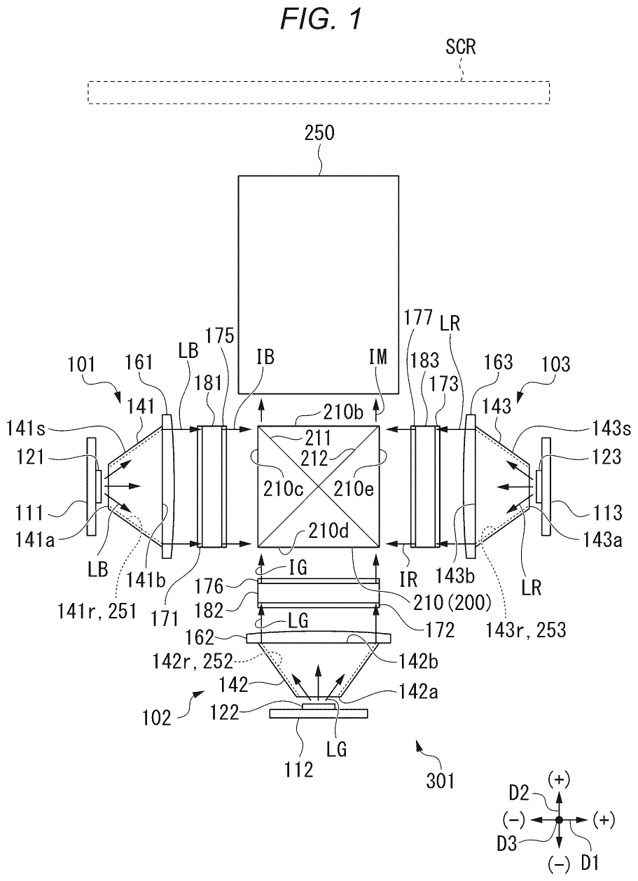

The embodiment of the present disclosure will first be described with reference to FIGS. 1 to 5. FIG. 1 is a schematic view showing the configuration of a projector 301 according to the embodiment of the present disclosure. The projector 301 is an image display apparatus including three liquid crystal panels as a light modulating apparatus, and is what is called a three-plate projector. The projector 301 includes a blue light outputting section 101, a green light outputting section 102, a red light outputting section 103, light-incident-side polarizers 171, 172, and 173, light modulators 181, 182, and 183, light-exiting-side polarizers 175, 176, and 177, a light combiner 200, and a projection system 250, as shown in FIG. 1.

The blue light outputting section 101 outputs blue light LB. In the following description, an axis parallel to the optical axis of the blue light LB output from the blue light outputting section 101 is referred to as a D1 direction. One side in the D1 direction is referred to as a −D1 side, and the side opposite from the −D1 side in the D1 direction is referred to as a +D1 side. The direction perpendicular to the D1 direction in a plane containing the optical axis of the blue light LB is referred to as a D2 direction. One side in the D2 direction is referred to as a −D2 side, and the side opposite from the −D2 side in the D2 direction is referred to as a +D2 side. The direction perpendicular to the D1 and D2 directions is referred to as a D3 direction. The blue light LB output from the blue light outputting section 101 travels toward the +D1 side along the D1 direction.

The blue light outputting section 101 includes a light source 401, a light guide 141, and a parallelizing element 161. The light source 401 corresponds to a first light source. A light emitting device 121 of the light source 401 is supported by a substrate 111. The light emitting device 121 is provided at the +D1-side plate surface of the substrate 111 out of the plate surfaces of the substrate 111 that are parallel to a plane containing the D2 and D3 directions. The substrate 111 corresponds to a base. The light emission surface of the light emitting device 121 is located substantially in parallel to the plane containing the D2 and D3 directions, and is a surface opposite in the D1 direction from the surface of the light emitting device 121 that faces the +D1-side plate surface of the substrate 111. The light emitting device 121 corresponds to a first light emitting device, and outputs the blue light LB having a blue wavelength band in a visible wavelength band. The blue wavelength band corresponds to a first wavelength band. The blue light LB corresponds to first light. The blue light LB exits via the light emission surface of the light emitting device 121 toward the +D1 side while diverging in accordance with a predetermined radiation angle around the axis passing through the center of the light emission surface of the light emitting device 121 and parallel to the D1 direction. The blue wavelength band is, for example, a wavelength band ranging from 420 nm to 500 nm.

The light emitting device 121 is configured, for example, with an LED that emits the blue light LB. Note that the light emitting device 121 may be configured with one LED or multiple LEDs in their entirety. When the light emitting device 121 is configured with multiple LEDs, the multiple LEDs are arranged in the region occupied by the light emitting device 121 in a plane containing the D2 and D3 directions.

The substrate 111 is made, for example, of metal, and also acts as a heat dissipating member that receives heat, for example, from the light emitting device 121 emitting the blue light LB and dissipates the heat to an external space.

The light guide 141 is provided in the optical path of the blue light LB output from the light source 401, and is disposed at a position which is shifted toward the +D1 side from the light emitting device 121 of the light source 401 and where the light guide 141 overlaps with the light emitting device 121 in the D2 and D3 directions. The light guide 141 corresponds to a first light guide, and has a light incident end 141a facing the −D1 side in the D1 direction, a light exiting end 141b facing the +D1 side in the D1 direction, and side surfaces 141s and reflection surfaces 141r extending between the light incident end 141a and the light exiting end 141b in the D1 direction.

The light incident end 141a corresponds to a first light incident end and spreads in parallel to the plane containing the D2 and D3 directions. The light incident end 141a viewed in the D1 direction has the same shape as the light emission surface of the light emitting device 121 viewed in the same direction, and has, for example, a quadrangular shape. The size of the light incident end 141a in a plane containing the D2 and D3 directions may be equal to the size of the light emission surface of the light emitting device 121 in a plane containing the D2 and D3 directions, but is preferably appropriately greater than the size of the light emission surface of the light emitting device 121 in the plane containing the D2 and D3 directions.

The light exiting end 141b corresponds to a first light exiting end, spreads in parallel to the plane containing the D2 and D3 directions, and is larger than the light incident end 141a. The light exiting end 141b viewed in the D1 direction has the same shape as the light modulation surface of the light modulator 181 viewed in the same direction, is similar to the modulation surface of the light modulator 181, and has, for example, a quadrangular shape. The size of the light exiting end 141b in a plane containing the D2 and D3 directions is equal to the size of the light modulation surface of the light modulator 181 in a plane containing the D2 and D3 directions. The side surfaces 141s and the reflection surfaces 141r couple the circumferential edge of the light incident end 141a to the circumferential edge of the light exiting end 141b in the D1 direction.

The blue light LB output from the light source 401 enters the light guide 141 via the light incident end 141a. In the light guide 141, the region surrounded by the light incident end 141a, the light exiting end 141b, and the reflection surfaces 141r is a region through which the blue light LB propagates. The size, in planes containing the D2 and D3 directions, of the region surrounded by the light incident end 141a, the light exiting end 141b, and the reflection surfaces 141r increases as the region extends from the −D1 side toward the +D1 side in the D1 direction. Furthermore, the shape, in the planes containing the D2 and D3 directions, of the region surrounded by the light incident end 141a, the light exiting end 141b, and the reflection surfaces 141r changes from the shape of the light emission surface of the light emitting device 121 to the shape of the light modulation surface of the light modulator 181 when viewed in the D1 direction as the region extends from the −D1 side toward the +D1 side.

The side surfaces 141s of the light guide 141 and the reflection surfaces 141r provided at the side surfaces 141s as will be described later incline by a predetermined angle with respect to an imaginary line and the optical axis perpendicular to the light incident end 141a, and are separate away from the imaginary line in the planes containing the D2 and D3 directions as the light guide 141 extends from the −D1 side toward the +D1 side. The blue light LB having entered the light guide 141 propagates from the −D1 side toward the +D1 side in the region surrounded by the light incident end 141a, the light exiting end 141b, and the reflection surfaces 141r.

When the light modulation surface of the light modulator 181 has a rectangular shape when viewed along the D1 direction, the light emission surface of the light emitting device 121 viewed along the D1 direction is substantially similar to the modulation surface of the light modulator 181, and has a rectangular shape. In this case, it is preferable that a predetermined angle α of the side surfaces 141s and the reflection surfaces 141r containing the short sides of the rectangular shape with respect to the imaginary line and the optical axis described above, that is, the taper angle falls within a range from 7° to 22°. It is preferable that a predetermined angle β of the side surfaces 141s and the reflection surfaces 141r containing the long sides of the rectangular shape with respect to the imaginary line and the optical axis described above, that is, the taper angle falls within a range from 14° to 36°. The preferable ranges of the angles α and β have been ascertained by a numerical simulation based on the configuration of the blue light outputting section 101 and ray tracing.

Part of the blue light LB having entered the light guide 141 propagates directly from the light incident end 141a to the light exiting end 141b without being incident on the reflection surfaces 141r even once along directions that incline by angles smaller than one of the two predetermined angles with respect to the imaginary line and the optical axis described above. The remaining part of the blue light LB having entered the light guide 141 inclines by angles greater than or equal to one of the two predetermined angles with respect to the imaginary line and the optical axis described above, is incident on the reflection surfaces 141r via the light incident end 141a once or a greater number of times, is reflected off the reflection surfaces 141r, and then reaches the light exiting end 141b. The paths of beams constituting the blue light LB in the region surrounded by the light incident end 141a, the light exiting end 141b, and the reflection surfaces 141r vary in accordance with the angles of incidence of the beams incident on the light incident end 141a, and there are multiple paths along which the beams are reflected off the reflection surfaces 141r by different numbers of times. The illuminance distribution of the blue light LB that propagates through the region surrounded by the light incident end 141a, the light exiting end 141b, and the reflection surfaces 141r is therefore homogenized in the planes containing the D2 and D3 directions. That is, the light guide 141 homogenizes the illuminance distribution of the incident blue light LB in the planes containing the D2 and D3 directions. The blue light LB having the homogenized illuminance distribution exits via the light exiting end 141b toward the +D1 side.

The light guide 141 is, for example, a reflector made of a transparent material such as optical glass. The reflector is formed as a hollow member having a frame body. When viewed along the D1 direction, the −D1-side end of the frame body of the reflector has the same shape as the light incident end 141a and the light emission surface of the light emitting device 121, is larger than the light emission surface of the light emitting device 121, and is formed, for example, in the shape of a quadrangular frame. The +D1-side end of the frame body of the reflector has the same shape and size as the light exiting end 141b and the light modulation surface of the light modulator 181, and is formed, for example, in the shape of a quadrangular frame different in size from the −D1-side end.

The reflector is configured, for example, with a plate-shaped member made of a transparent material. When the light incident end 141a and the light exiting end 141b have quadrangular shapes when viewed in the D1 direction, as described above, the reflector is configured with four plate-shaped members each having a trapezoidal shape. The length of the sides facing the −D1 side that are parallel to the D2 or D3 direction and correspond to the upper bases of the four plate-shaped members is set in accordance with the size of the light incident end 141a and the light emission surface of the light emitting device 121 in the D2 or D3 direction. The length of the sides facing the +D1 side that are parallel to the D2 or D3 direction and correspond to the lower bases of the four plate-shaped members is set in accordance with the size of the light exiting end 141b and the light modulation surface of the light modulator 181 in the D2 or D3 direction. Out of the four plate-shaped members, a side corresponding to one leg of one of two adjacent plate-shaped members is coupled to a side corresponding to the other leg of the other plate-shaped member.

When the reflector constituting the light guide 141 is configured with the plate-shaped transparent members as described above, the side surfaces 141s, that is, the plate surfaces of the plate-shaped members that face the space outside the reflector act as the reflection surfaces. To increase the reflectance of the side surfaces 141s and portions in the vicinity thereof for the blue light LB having entered the light guide 141 via the light incident end 141a, the reflector constituting the light guide 141 is provided with a reflection film 251 configured, for example, with a dielectric multilayer film at the plate surface of each of the plate-shaped members constituting the reflector that is opposite from the side surface 141s, that is, the plate surface facing an internal space SP141. In this case, the plate surface of each of the plate-shaped members that faces the internal space SP141 inside the reflector acts as the reflection surface 141r. Part of the blue light LB having entered the internal space SP141 inside the reflector constituting the light guide 141 via the light incident end 141a is reflected off the reflection films 251 and travels toward the +D1 side.

The intensity of the blue light LB reflected off the reflection films 251 and output from the reflection films 251 depends in some cases on the angle of incidence of the blue light LB incident on the reflection films 251. When the reflection films 251 are each configured with a dielectric multilayer film, the dependence of the intensity of the blue light LB output from the reflection films 251 on the angle of incidence changes in accordance, for example, with the refractive index of multiple films contained in the dielectric multilayer film, the thickness of each of the films, the number of films, and other parameters. For example, when the angle α falls within the range from 7° to 22° and the angle β falls within the range from 14° to 36° as described above, the reflection films 251 are designed and the parameters of the dielectric multilayer film are appropriately determined in such a way that the angle of incidence of the blue light LB output from the reflection surfaces 141r and the reflection films 251 at which the intensity of the blue light LB is maximized falls within a range, for example, from 60° to 90°. The relationship between the angle of incidence of the blue light LB incident on the reflection surfaces 141r and the reflection films 251 and the intensity of the blue light LB output from the reflection surfaces 141r and the reflection films 251 is derived by a numerical simulation based on the configuration of the blue light outputting section 101 and ray tracing.

Note that when the reflector is configured with plate-shaped transparent members, and the plate surface of each of the plate-shaped members that faces the space outside the reflector act as the reflection surface, part of the blue light LB having entered the internal space SP141 inside the reflector constituting the light guide 141 via the light incident end 141a enters the plate-shaped members via the plate surfaces of the plate-shaped members that face the internal space SP141 inside the reflector, is refracted at the plate surfaces facing the internal space SP141, is reflected off the plate surfaces of the plate-shaped members that face the space outside the reflector, propagates through the plate-shaped members again, is refracted at the plate surfaces facing the internal space SP141 inside the reflector, and exits into the internal space SP141 inside the reflector, and travels toward the +D1 side.

The parallelizing element 161 is provided in the optical path of the blue light LB output from the light guide 141, and is disposed at a position which is shifted toward the +D1 side from the light guide 141 and where the parallelizing element 161 overlaps with the light guide 141 in the D2 and D3 directions. The parallelizing element 161 corresponds to a first parallelizing element, and parallelizes the blue light LB output from the light guide 141 along the D1 direction.

The parallelizing element 161 is, for example, a plano-convex lens, and has a light incident surface configured with a planar surface perpendicular to the D1 direction, and a light exiting surface configured with a convex curved surface protruding toward the side via which the blue light LB exits. The light incident surface of the plano-convex lens constituting the parallelizing element 161 is in contact with the light exiting end 141b of the light guide 141. Since the parallelizing element 161 is in contact with the light exiting end 141b, the blue light LB output via the light exiting end 141b of the light guide 141 is introduced as much as possible into the parallelizing element 161, so that loss of the blue light LB can be suppressed. The parallelizing element 161 may instead be an optical lens that can parallelize the incident blue light LB other than a plano-convex lens. The parallelizing element 161 may be disposed at an appropriate distance from the light guide 141 in the D1 direction.

The light-incident-side polarizer 171 is provided in the optical path of the blue light LB output from the parallelizing element 161, and is disposed at a position which is shifted toward the +D1 side from the parallelizing element 161 and where the light-incident-side polarizer 171 overlaps with the parallelizing element 161 in the D2 and D3 directions. The light-incident-side polarizer 171 is in contact, for example, with the −D1 side of the light modulator 181, and may instead be disposed at an appropriate distance from the light modulator 181 in the D1 direction. The light-incident-side polarizer 171 corresponds to a first polarizer, and outputs predetermined polarized light out of the blue light LB output from the parallelizing element 161 toward the +D1 side along the D1 direction. The predetermined polarized light corresponds to a first polarized component, and is, for example, S-polarized light.

The light-incident-side polarizer 171 is, for example, a reflective or absorptive polarizing plate having plate surfaces parallel to the plane containing the D2 and D3 directions. When it is desired to suppress return light and stray light directed to upstream optical elements including the parallelizing element 161, it is desirable to employ an absorptive polarizing plate as the light-incident-side polarizer 171. The light-incident-side polarizer 171 transmits part of the incident blue light LB that contains the predetermined polarized light toward the +D1 side, and absorbs or reflects the other part of the blue light LB toward the −D1 side.

The light modulator 181 is provided in the optical path of the blue light LB output from the light-incident-side polarizer 171, and is disposed at a position which is shifted toward the +D1 side from the light-incident-side polarizer 171 and where the light modulator 181 overlaps with the light-incident-side polarizer 171 in the D2 and D3 directions. The light modulator 181 corresponds to a first light modulator, and modulates the blue light LB output from the light-incident-side polarizer 171 based on image information input from an image formation apparatus that is not shown but is externally coupled to the light modulator 181, such as a computer.

The light modulator 181 is, for example, a transmissive liquid crystal panel. The liquid crystal panel constituting the light modulator 181 has multiple pixels that are not shown. The pixels each include a switching element. The switching element is, for example, a polysilicon thin film transistor (TFT). An electric signal according to the brightness of the red light at the relative position of each of the pixels at the light modulation surface of the light modulator 181 in an image projected by the projector 301 is supplied to the switching element of the pixel. The pixels each modulate the vibration direction of the blue light LB incident from the light-incident-side polarizer 171 with the aid of the operation of the switching element according to the electric signal described above to generate blue image light IB. The image light IB corresponds to the first light. The light modulator 181 outputs the image light IB generated by the liquid crystal panel toward the +D1 side along the D1 direction.

The light-exiting-side polarizer 175 is provided in the optical path of the image light IB output from the light modulator 181, and is disposed at a position which is shifted toward the +D1 side from the light modulator 181 where the light-exiting-side polarizer 175 overlaps with the light modulator 181 in the D2 and D3 directions. The light-exiting-side polarizer 175 is in contact, for example, with the +D1 side of the light modulator 181, and may instead be disposed at an appropriate distance from the light modulator 181 in the D1 direction. The light-exiting-side polarizer 175 corresponds to a fourth polarizer, and outputs predetermined polarized light out of the image light IB output from the light modulator 181 toward the +D1 side along the D1 direction. The predetermined polarized light corresponds to a fourth polarized component, and is, for example, P-polarized light.

The light-exiting-side polarizer 175 is, for example, a reflective or absorptive polarizing plate having plate surfaces parallel to the plane containing the D2 and D3 directions. When it is desired to suppress return light and stray light directed to the light modulator 181, it is desirable to employ an absorptive polarizing plate as the light-exiting-side polarizer 175. The light-exiting-side polarizer 175 transmits part of the incident image light IB that contains the predetermined polarized light toward the +D1 side, and absorbs or reflects the other part of the image light IB toward the −D1 side.

The green light outputting section 102 is disposed at a position shifted toward the +D1 side and the −D2 side from the blue light outputting section 101 in a region where the green light outputting section 102 overlaps with the blue light outputting section 101 in the D3 direction. The green light outputting section 102 outputs green light LG. The green light LG output from the green light outputting section 102 travels toward the +D2 side along the D2 direction.

The green light outputting section 102 includes a light source 402, a light guide 142, and a parallelizing element 162. The light source 402 corresponds to a second light source. A light emitting device 122 of the light source 402 is supported by a substrate 112. The light emitting device 122 is provided at the +D2-side plate surface of the substrate 112 out of the plate surfaces of the substrate 112 that are parallel to a plane containing the D1 and D3 directions. The light emission surface of the light emitting device 122 is located substantially in parallel to the plane containing the D1 and D3 directions, and is a surface opposite in the D2 direction from the surface of the light emitting device 122 that is in contact with the +D2-side plate surface of the substrate 112. The light emitting device 122 corresponds to a second light emitting device, and outputs the green light LG having a green wavelength band in the visible wavelength band. The green wavelength band corresponds to a second wavelength band. The green light LG corresponds to second light. The green light LG exits via the light emission surface of the light emitting device 122 toward the +D2 side while diverging in accordance with a predetermined radiation angle around the axis passing through the center of the light emission surface of the light emitting device 122 and parallel to the D2 direction. The green wavelength band is, for example, a wavelength band ranging from 500 nm to 600 nm.

The light emitting device 122 includes, for example, a light emitter that emits excitation light and a phosphor that is excited by the excitation light emitted from the light emitter and emits the green light LG, as will be described later. Note that the light emitter of the light emitting device 122 may be configured with one LED or multiple LEDs in their entirety, as the light emitter of the light emitting device 121. When the light emitter of the light emitting device 122 is configured with multiple LEDs, the multiple LEDs are arranged in the region occupied by the light emitting device 122 in the plane containing the D1 and D3 directions.

The substrate 112 is made, for example, of metal, and also acts as a heat dissipation member that receives heat, for example, from the light emitting device 122 emitting the green light LG and dissipates the heat to an external space.

The light guide 142 is provided in the optical path of the green light LG output from the light source 402, and is disposed at a position which is shifted toward the +D2 side from the light emitting device 122 of the light source 402 and where the light guide 142 overlaps with the light emitting device 122 in the D1 and D3 directions. The light guide 142 corresponds to a second light guide, and has a light incident end 142a facing the −D2 side in the D2 direction, a light exiting end 142b facing the +D2 side in the D2 direction, and side surfaces 142s and reflection surfaces 142r extending between the light incident end 142a and the light exiting end 142b in the D2 direction.

The light incident end 142a corresponds to a second light incident end and spreads in parallel to the plane containing the D1 and D3 directions. The light incident end 142a viewed in the D2 direction has the same shape as the light emission surface of the light emitting device 122 viewed in the same direction, and has, for example, a quadrangular shape. The size of the light incident end 142a in a plane containing the D1 and D3 directions may be equal to the size of the light emission surface of the light emitting device 122 in a plane containing the D1 and D3 directions, and is preferably appropriately greater than the size of the light emission surface of the light emitting device 122 in the plane containing the D1 and D3 directions.

The light exiting end 142b corresponds to a second light exiting end, spreads in parallel to the plane containing the D1 and D3 directions, and is larger than the light incident end 142a. The light exiting end 142b viewed in the D2 direction has the same shape as the light modulation surface of the light modulator 182 viewed in the same direction, is similar to the modulation surface of the light modulator 182, and has, for example, a quadrangular shape. The size of the light exiting end 142b in a plane containing the D1 and D3 directions is equal to the size of the light modulation surface of the light modulator 182 in a plane containing the D1 and D3 directions. The side surfaces 142s and the reflection surfaces 142r couple the circumferential edge of the light incident end 142a to the circumferential edge of the light exiting end 142b in the D2 direction.

The green light LG output from the light source 402 enters the light guide 142 via the light incident end 142a. In the light guide 142, the region surrounded by the light incident end 142a, the light exiting end 142b, and the reflection surfaces 142r is a region through which the green light LG propagates. The size, in planes containing the D1 and D3 directions, of the region surrounded by the light incident end 142a, the light exiting end 142b, and the reflection surfaces 142r increases as the region extends from the −D2 side toward the +D2 side in the D2 direction. Furthermore, the shape, in the planes containing the D1 and D3 directions, of the region surrounded by the light incident end 142a, the light exiting end 142b, and the reflection surfaces 142r changes from the shape of the light emission surface of the light emitting device 122 to the shape of the light modulation surface of the light modulator 182 when viewed in the D2 direction as the region extends from the −D2 side toward the +D2 side.

The side surfaces 142s of the light guide 142 and the reflection surfaces 142r provided at the side surfaces 142s as will be described later incline by a predetermined angle with respect to an imaginary line and the optical axis perpendicular to the light incident end 142a, and are separate away from the imaginary line in the planes containing the D1 and D3 directions as the light guide 142 extends from the −D2 side toward the +D2 side. The green light LG having entered the light guide 142 propagates from the −D2 side toward the +D2 side in the region surrounded by the light incident end 142a, the light exiting end 142b, and the reflection surfaces 142r.

When the light modulation surface of the light modulator 182 has a rectangular shape when viewed along the D2 direction, a light emission surface 122e of the light emitting device 122 viewed along the D2 direction is substantially similar to the modulation surface of the light modulator 182, and has a rectangular shape. In this case, it is preferable that the predetermined angle α of the side surfaces 142s and the reflection surfaces 142r containing the short sides of the rectangular shape with respect to the imaginary line and the optical axis described above falls within the range from 7° to 22°. It is preferable that the predetermined angle β of the side surfaces 142s and the reflection surfaces 142r containing the long sides of the rectangular shape with respect to the imaginary line and the optical axis described above falls within the range from 14° to 36°. The preferable ranges of the angles α and β have been ascertained by a numerical simulation based on the configuration of the green light outputting section 102 and ray tracing.

Part of the green light LG having entered the light guide 142 propagates directly from the light incident end 142a to the light exiting end 142b without being incident on the reflection surfaces 142r even once along directions that incline by angles smaller than the angle α or β with respect to the imaginary line and the optical axis described above. The remaining part of the green light LG having entered the light guide 142 inclines by angles greater than or equal to the angle α or β with respect to the imaginary line and the optical axis described above, is incident on the reflection surfaces 142r via the light incident end 142a once or a greater number of times, is reflected off the reflection surfaces 142r, and then reaches the light exiting end 142b.

The paths of the beams constituting the green light LG in the region surrounded by the light incident end 142a, the light exiting end 142b, and the reflection surfaces 142r vary in accordance with the angles of incidence of the beams incident on the light incident end 142a, and there are multiple paths along which the beams are reflected off the reflection surfaces 142r by different numbers of times. The illuminance distribution of the green light LG that propagates through the region surrounded by the light incident end 142a, the light exiting end 142b, and the reflection surfaces 142r is therefore homogenized in the planes containing the D1 and D3 directions. That is, the light guide 142 homogenizes the illuminance distribution of the incident green light LG in the planes containing the D1 and D3 directions. The green light LG having the homogenized illuminance distribution exits via the light exiting end 142b toward the +D2 side.

The light guide 142 is a hollow reflector configured with plate-shaped members made of a transparent material such as optical glass, as the light guide 141. When viewed along the D2 direction, the −D2-side end of the frame body of the reflector has the same shape as the light incident end 142a and the light emission surface of the light emitting device 122, is larger by an appropriate degree than the light emission surface of the light emitting device 122, and is formed, for example, in the shape of a quadrangular frame. The +D2-side end of the frame body of the reflector has the same shape and size as the light exiting end 142b and the light modulation surface of the light modulator 182, and is formed, for example, in the shape of a quadrangular frame different in size from the −D2-side end.

The reflector constituting the light guide 142 is configured with four plate-shaped members each having a trapezoidal shape with the sides corresponding to the legs of the trapezoidal shape coupled to each other. The length of the sides facing the −D2 side that are parallel to the D1 or D3 direction and correspond to the upper bases of the four plate-shaped members is set in accordance with the size of the light incident end 142a and the light emission surface of the light emitting device 122 in the D1 or D3 direction. The length of the sides facing the +D2 side that are parallel to the D1 or D3 direction and correspond to the lower bases of the four plate-shaped members is set in accordance with the size of the light exiting end 142b and the light modulation surface of the light modulator 182 in the D1 or D3 direction.

When the reflector constituting the light guide 142 is configured with the plate-shaped transparent members as described above, the side surfaces 142s, that is, the plate surfaces of the plate-shaped members that face the space outside the reflector act as the reflection surfaces. To increase the reflectance of the side surface 142s and portions in the vicinity thereof for the green light LG having entered the light guide 142 via the light incident end 142a, the reflector constituting the light guide 142 is also provided with a reflection film 252 configured, for example, with a dielectric multilayer film at the plate surface of each of the plate-shaped members constituting the reflector that is opposite from the side surface 142s, that is, the plate surface facing an internal space SP142 inside the plate-shaped member. In this case, the plate surface of each of the plate-shaped members that faces the internal space SP142 inside the reflector acts as the reflection surface 142r. Part of the green light LG having entered the internal space SP142 inside the reflector constituting the light guide 142 via the light incident end 142a is reflected off the reflection films 252 and travels toward the +D2 side.

The intensity of the green light LG reflected off the reflection films 252 and output from the reflection films 252 depends in some cases on the angle of incidence of the green light LG incident on the reflection films 252. When the reflection films 252 are each configured with a dielectric multilayer film, the dependence of the intensity of the green light LG output from the reflection films 252 on the angle of incidence changes in accordance, for example, with the refractive index of multiple films contained in the dielectric multilayer film, the thickness of each of the films, the number of films, and other parameters. For example, when the angle α falls within the range from 7° to 22° and the angle β falls within the range from 14° to 36° as described above, the reflection films 252 are designed and the parameters of the dielectric multilayer film are appropriately determined in such a way that the angle of incidence of the green light LG output from the reflection surfaces 142r and the reflection films 252 at which the intensity of the green light LG is maximized falls within the range, for example, from 60° to 90°. The relationship between the angle of incidence of the green light LG incident on the reflection surfaces 142r and the reflection films 252 and the intensity of the green light LG output from the reflection surface 142r and the reflection films 252 is derived by a numerical simulation based on the configuration of the green light outputting section 102 and ray tracing.

Note that when the reflector constituting the light guide 142 is configured with plate-shaped transparent members, and the plate surface of each of the plate-shaped members that faces the space outside the reflector act as the reflection surface, part of the green light LG having entered the internal space SP142 inside the reflector constituting the light guide 142 via the light incident end 142a enters the plate-shaped members via the plate surfaces of the plate-shaped members that face the internal space SP142 inside the reflector, is refracted at the plate surfaces facing the internal space SP142, is reflected off the plate surfaces of the plate-shaped members that face the space outside the reflector, propagates through the plate-shaped members again, is refracted at the plate surfaces facing the internal space SP142 inside the reflector, and exits into the internal space SP142 inside the reflector, and travels toward the +D2 side.

The parallelizing element 162 is provided in the optical path of the green light LG output from the light guide 142, and is disposed at a position which is shifted toward the +D2 side from the light guide 142 and where the parallelizing element 162 overlaps with the light guide 142 in the D1 and D3 directions. The parallelizing element 162 corresponds to a second parallelizing element, and parallelizes the green light LG output from the light guide 142 along the D2 direction.

The parallelizing element 162 is, for example, a plano-convex lens, and has a light incident surface configured with a planar surface perpendicular to the D2 direction, and a light exiting surface configured with a convex curved surface protruding toward the side via which the green light LG exits. The light incident surface of the parallelizing element 162 is in contact with the light exiting end 142b of the light guide 142. Since the parallelizing element 162 is in contact with the light exiting end 142b, the green light LG output via the light exiting end 142b of the light guide 142 is introduced as much as possible into the parallelizing element 162, so that loss of the green light LG can be suppressed. The parallelizing element 162 may instead be an optical lens that can parallelize the incident green light LG other than a plano-convex lens. The parallelizing element 162 may be disposed at an appropriate distance from the light guide 142 in the D2 direction.

The light-incident-side polarizer 172 is provided in the optical path of the green light LG output from the parallelizing element 162, and is disposed at a position shifted toward the +D2 side from the parallelizing element 162 and where the light-incident-side polarizer 172 overlaps with the parallelizing element 162 in the D1 and D3 directions. The light-incident-side polarizer 172 is in contact, for example, with the +D2 side of the light modulator 182, and may instead be disposed at an appropriate distance from the light modulator 182 in the D2 direction. The light-incident-side polarizer 172 corresponds to a second polarizer, and outputs predetermined polarized light out of the green light LG output from the parallelizing element 162 toward the +D2 side along the D2 direction. The predetermined polarized light corresponds to a second polarized component, and is, for example, S-polarized light.

The light-incident-side polarizer 172 is, for example, a reflective or absorptive polarizing plate having plate surfaces parallel to the plane containing the D1 and D3 directions. When it is desired to suppress return light and stray light directed to optical elements including the parallelizing element 162 upstream from the light-incident-side polarizer 172, it is desirable to employ an absorptive polarizer as the light-incident-side polarizer 172. The light-incident-side polarizer 172 transmits part of the incident green light LG that contains the predetermined polarized light toward the +D2 side, and absorbs or reflects the other part of the green light LG toward the −D2 side.

The light modulator 182 is provided in the optical path of the green light LG output from the light-incident-side polarizer 172, and is disposed at a position shifted toward the +D2 side from the light-incident-side polarizer 172 and where the light modulator 182 overlaps with the light-incident-side polarizer 172 in the D1 and D3 directions. The light modulator 182 corresponds to a second light modulator, and modulates the green light LG output from the light-incident-side polarizer 172 based on image information input from the image formation apparatus that is not shown but is externally coupled to the light modulator 182, such as a computer.

The light modulator 182 is, for example, a transmissive liquid crystal panel. The liquid crystal panel constituting the light modulator 182 has multiple pixels that are not shown. The pixels each include a switching element. The switching element is, for example, a TFT. An electric signal according to the brightness of the green light at the relative position of each of the pixels at the light modulation surface of the light modulator 182 in an image projected by the projector 301 is supplied to the switching element in the pixel. The pixels each modulate the vibration direction of the green light LG incident from the light-incident-side polarizer 172 with the aid of the operation of the switching element according to the electric signal described above to generate green image light IG. The image light IG corresponds to the second light. The light modulator 182 outputs the image light IG generated by the liquid crystal panel toward the +D2 side along the D2 direction.

The light-exiting-side polarizer 176 is provided in the optical path of the image light IG output from the light modulator 182, and is disposed at a position shifted toward the +D2 side from the light modulator 182 and where the light-exiting-side polarizer 176 overlaps with the light modulator 182 in the D1 and D3 directions. The light-exiting-side polarizer 176 is in contact, for example, with the +D2 side of the light modulator 182, and may instead be disposed at an appropriate distance from the light modulator 182 in the D2 direction. The light-exiting-side polarizer 176 corresponds to a fifth polarizer, and outputs predetermined polarized light out of the image light IG output from the light modulator 182 toward the +D2 side along the D2 direction. The predetermined polarized light corresponds to a fifth polarized component, and is, for example, P-polarized light.

The light-exiting-side polarizer 176 is, for example, a reflective or absorptive polarizing plate having plate surfaces parallel to the plane containing the D1 and D3 directions. When it is desired to suppress return light and stray light directed to the light modulator 182, it is desirable to employ an absorptive polarizing plate as the light-exiting-side polarizer 176. The light-exiting-side polarizer 176 transmits part of the incident image light IG that contains the predetermined polarized light toward the +D2 side, and absorbs or reflects the other part of the image light IG toward the −D2 side.

The red light outputting section 103 is disposed at a position shifted toward the +D1 side from the green light outputting section 102 in a region where the red light outputting section 103 overlaps with the blue light emitter 101 in the D2 and D3 directions. The red light outputting section 103 outputs red light LR. The red light LR output from the red light outputting section 103 travels toward the −D1 side along the D1 direction.

The red light outputting section 103 includes a light source 403, a light guide 143, and a parallelizing element 163. The light source 403 corresponds to a third light source. A light emitting device 123 of the light source 403 is supported by a substrate 113. The light emitting device 123 is provided at the −D1-side plate surface of the substrate 113 out of the plate surfaces of the substrate 113 that are parallel to the plane containing the D2 and D3 directions. The light emission surface of the light emitting device 123 is located substantially in parallel to the plane containing the D2 and D3 directions, and is a surface opposite in the D1 direction from the surface of the light emitting device 123 that is in contact with the −D1-side plate surface of the substrate 113. The light emitting device 123 corresponds to a third light emitting device, and outputs the red light LR having a red wavelength band in the visible wavelength band. The red wavelength band corresponds to a third wavelength band. The red light LR corresponds to third light. The red light LR exits via the light emission surface of the light emitting device 123 toward the −D1 side while diverging in accordance with a predetermined radiation angle around the axis passing through the center of the light emission surface of the light emitting device 123 and parallel to the D1 direction. The red wavelength band is, for example, a wavelength band ranging from 610 nm to 700 nm.

The light emitting device 123 is configured, for example, with an LED that emits the red light LR. Note that the light emitting device 123 may be configured with one LED or multiple LEDs in their entirety, as the light emitting devices 121 and 122. When the light emitting device 123 is configured with multiple LEDs, the multiple LEDs are arranged in the region occupied by the light emitting device 123 in the plane containing the D2 and D3 directions.

The substrate 113 is made, for example, of metal, and also acts as a heat dissipation member that receives heat, for example, from the light emitting device 123 outputting the red light LR and dissipates the heat to an external space.

The light guide 143 is provided in the optical path of the red light LR output from the light source 403, and is disposed at a position shifted toward the −D1 side from the light emitting device 123 of the light source 403 and where the light guide 143 overlaps with the light emitting device 123 in the D2 and D3 directions. The light guide 143 corresponds to a third light guiding element, and has a light incident end 143a facing the +D1 side in the D1 direction, a light exiting end 143b facing the −D1 side in the D1 direction, and side surfaces 143s and reflection surfaces 143r extending between the light incident end 143a and the light exiting end 143b in the D1 direction.

The light incident end 143a corresponds to a third light incident end and spreads in parallel to the plane containing the D2 and D3 directions. The light incident end 143a viewed in the D1 direction has the same shape as the light emission surface of the light emitting device 123 viewed in the same direction, and has, for example, a quadrangular shape. The size of the light incident end 143a in a plane containing the D2 and D3 directions may be equal to the size of the light emission surface of the light emitting device 123 in a plane containing the D2 and D3 directions, and is preferably appropriately greater than the size of the light emission surface of the light emitting device 123 in the plane containing the D2 and D3 directions.

The light exiting end 143b corresponds to a third light exiting end, spreads in parallel to the plane containing the D2 and D3 directions, and is larger than the light incident end 143a. The light exiting end 143b viewed in the D1 direction has the same shape as the light modulation surface of the light modulator 183 viewed in the same direction, is similar to the modulation surface of the light modulator 183, and has, for example, a quadrangular shape. The size of the light exiting end 143b in a plane containing the D2 and D3 directions is equal to the size of the light modulation surface of the light modulator 183 in a plane containing the D2 and D3 directions. The side surfaces 143s and the reflection surfaces 143r couple the circumferential edge of the light incident end 143a to the circumferential edge of the light exiting end 143b in the D1 direction.

The red light LR output from the light source 403 enters the light guide 143 via the light incident end 143a. In the light guide 143, the region surrounded by the light incident end 143a, the light exiting end 143b, and the reflection surfaces 143r is a region through which the red light LR propagates. The size, in planes containing the D2 and D3 directions, of the region surrounded by the light incident end 143a, the light exiting end 143b, and the reflection surfaces 143r increases as the region extends from the +D1 side toward the −D1 side in the D1 direction. Furthermore, the shape, in the planes containing the D2 and D3 directions, of the region surrounded by the light incident end 143a, the light exiting end 143b, and the reflection surfaces 143r changes from the shape of the light emission surface of the light emitting device 123 to the shape of the light modulation surface of the light modulator 183 when viewed in the D1 direction as the region extends from the +D1 side toward the −D1 side.

The side surfaces 143s of the light guide 143 and the reflection surfaces 143r provided at the side surfaces 143s as will be described later incline by a predetermined angle with respect to an imaginary line and the optical axis perpendicular to the light incident end 143a, and are separate away from the imaginary line in the planes containing the D2 and D3 directions as the light guide 143 extends from the +D1 side toward the −D1 side. The red light LR having entered the light guide 142 propagates from the +D1 side toward the −D1 side in the region surrounded by the light incident end 143a, the light exiting end 143b, and the reflection surfaces 143r.

When the light modulation surface of the light modulator 183 has a rectangular shape when viewed along the D1 direction, the light emission surface of the light emitting device 123 viewed along the D1 direction is substantially similar to the modulation surface of the light modulator 183, and has, for example, a rectangular shape. In this case, it is preferable that the predetermined angle α of the side surfaces 143s and the reflection surfaces 143r containing the short sides of the rectangular shape with respect to the imaginary line and the optical axis described above falls within the range from 7° to 22°. It is preferable that the predetermined angle β of the side surfaces 143s and the reflection surfaces 143r containing the long sides of the rectangular shape with respect to the imaginary line and the optical axis described above falls within the range from 14° to 36°. The preferable ranges of the angles α and β have been ascertained by a numerical simulation based on the configuration of the red light outputting section 103 and ray tracing.

Part of the red light LR having entered the light guide 143 propagates directly from the light incident end 143a to the light exiting end 143b without being incident on the reflection surfaces 143r even once along directions that incline by angles smaller than the angle α or β with respect to the imaginary line and the optical axis described above. The remaining part of the red light LR having entered the light guide 143 inclines by angles greater than or equal to the angle α or β with respect to the imaginary line and the optical axis described above, is incident on the reflection surfaces 143r via the light incident end 143a once or a greater number of times, is reflected off the reflection surfaces 143r, and then reaches the light exiting end 143b. The paths of the beams constituting the red light LR in the region surrounded by the light incident end 143a, the light exiting end 143b, and the reflection surfaces 143r vary in accordance with the angles of incidence of the beams incident on the light incident end 143a, and there are multiple paths along which the beams are reflected off the reflection surfaces 143r by different numbers of times. The illuminance distribution of the red light LR that propagates through the region surrounded by the light incident end 143a, the light exiting end 143b, and the reflection surfaces 143r is therefore homogenized in the planes containing the D2 and D3 directions. That is, the light guide 143 homogenizes the illuminance distribution of the incident red light LR in the planes containing the D2 and D3 directions. The red light LR having the homogenized illuminance distribution exits via the light exiting end 143b toward the −D1 side.

The light guide 143 is a hollow reflector configured with plate-shaped members made of a transparent material such as optical glass, as the light guides 141 and 142. When viewed along the D1 direction, the +D1-side end of the frame body of the reflector has the same shape as the light incident end 143a and the light emission surface of the light emitting device 123, is larger by an appropriate degree than the light emission surface of the light emitting device 123, and is formed, for example, in the shape of a quadrangular frame. The −D1-side end of the frame body of the reflector has the same shape as the light exiting end 143b and the light modulation surface of the light modulator 183, and is formed, for example, in the shape of a quadrangular frame different in size from the +D1-side end.

The reflector constituting the light guide 143 is configured with four plate-shaped members each having a trapezoidal shape with the sides corresponding to the legs of the trapezoidal shape coupled to each other. The length of the sides facing the +D1 side that are parallel to the D2 or D3 direction and correspond to the upper bases of the four plate-shaped members is set in accordance with the size of the light incident end 143a and the light emission surface of the light emitting device 123 in the D2 or D3 direction. The length of the sides facing the −D1 side that are parallel to the D2 or D3 direction and correspond to the lower bases of the four plate-shaped members is set in accordance with the size of the light exiting end 143b and the light modulation surface of the light modulator 183 in the D2 or D3 direction.

When the reflector constituting the light guide 143 is configured with the plate-shaped transparent members as described above, the side surfaces 143s, that is, the plate surfaces of the plate-shaped members that face the space outside the reflector act as the reflection surfaces. To increase the reflectance of the side surface 143s and portions in the vicinity thereof for the red light LR having entered the light guide 143 via the light incident end 143a, the reflector constituting the light guide 143 is also provided with a reflection film 253 configured, for example, with a dielectric multilayer film at the plate surface of each of the plate-shaped members constituting the reflector that is opposite from the side surface 143s, that is, the plate surface facing an internal space SP143 inside the plate-shaped member. In this case, the plate surface of each of the plate-shaped members that faces the internal space SP143 inside the reflector acts as the reflection surface 143r. Part of the red light LR having entered the internal space SP143 inside the reflector constituting the light guide 143 via the light incident end 143a is reflected off the reflection films 253 and travels toward the −D1 side.

The intensity of the red light LR reflected off the reflection films 253 and output from the reflection films 253 depends in some cases on the angle of incidence of the red light LR incident on the reflection films 253. When the reflection films 253 are each configured with a dielectric multilayer film, the dependence of the intensity of the red light LR output from the reflection films 253 on the angle of incidence changes in accordance, for example, with the refractive index of multiple films contained in the dielectric multilayer film, the thickness of each of the films, the number of films, and other parameters. For example, when the angle α falls within the range from 7° to 22° and the angle β falls within the range from 14° to 36° as described above, the reflection films 253 are designed and the parameters of the dielectric multilayer film are appropriately determined in such a way that the angle of incidence of the red light LR output from the reflection surfaces 143r and the reflection films 253 at which the intensity of the red light LR is maximized falls within the range, for example, from 60° to 90°. The relationship between the angle of incidence of the red light LR incident on the reflection surfaces 143r and the reflection films 253 and the intensity of the red light LR output from the reflection surface 143r and the reflection films 253 is derived by a numerical simulation based on the configuration of the red light outputting section 103 and ray tracing.

Note that when the reflector constituting the light guide 143 is configured with plate-shaped transparent members, and the plate surface of each of the plate-shaped members that faces the space outside the reflector act as the reflection surface, part of the red light LR having entered the internal space SP143 inside the reflector constituting the light guide 143 via the light incident end 143a enters the plate-shaped members via the plate surfaces of the plate-shaped members that face the internal space SP143 inside the reflector, is refracted at the plate surfaces facing the internal space SP143, is reflected off the plate surfaces of the plate-shaped members that face the space outside the reflector, propagates through the plate-shaped members again, is refracted at the plate surfaces facing the internal space SP143 inside the reflector, and exits into the internal space SP143 inside the reflector, and travels toward the −D1 side.

The parallelizing element 163 is provided in the optical path of the red light LR output from the light guide 143, and is disposed at a position shifted toward the −D1 side from the light guide 143 and where the parallelizing element 163 overlaps with the light guide 143 in the D2 and D3 directions. The parallelizing element 163 corresponds to a third parallelizing element, and parallelizes the red light LR output from the light guide 143 along the D1 direction.

The parallelizing element 163 is, for example, a plano-convex lens, and has a light incident surface configured with a planar surface perpendicular to the D1 direction, and a light exiting surface configured with a convex curved surface protruding toward the side via which the red light LR exits. The light incident surface of the parallelizing element 163 is in contact with the light exiting end 143b of the light guide 143. Since the parallelizing element 163 is in contact with the light exiting end 143b, the red light LR output via the light exiting end 143b of the light guide 143 is introduced as much as possible into the parallelizing element 163, so that loss of the red light LR can be suppressed. The parallelizing element 163 may instead be an optical lens that can parallelize the incident red light LR other than a plano-convex lens. The parallelizing element 163 may be disposed at an appropriate distance from the light guide 143 in the D1 direction.

The light-incident-side polarizer 173 is provided in the optical path of the red light LR output from the parallelizing element 163, and is disposed at a position shifted toward the −D1 side from the parallelizing element 163 and where the light-incident-side polarizer 173 overlaps with the parallelizing element 163 in the D2 and D3 directions. The light-incident-side polarizer 173 is in contact, for example, with the +D1 side of the light modulator 183, and may instead be disposed at an appropriate distance from the light modulator 183 in the D1 direction.

The light-incident-side polarizer 173 corresponds to a third polarizer, and outputs predetermined polarized light out of the red light LR output from the parallelizing element 163 toward the −D1 side along the D1 direction. The predetermined polarized light corresponds to a third polarized component, and is, for example, S-polarized light. The light-incident-side polarizer 173 is, for example, a reflective or absorptive polarizing plate having plate surfaces parallel to the plane containing the D2 and D3 directions. When it is desired to suppress return light and stray light directed to optical elements including the parallelizing element 163 upstream from the light-incident-side polarizer 173, it is desirable to employ an absorptive polarizer as the light-incident-side polarizer 173. The light-incident-side polarizer 173 transmits part of the incident red light LR that contains the predetermined polarized light toward the −D1 side, and absorbs or reflects the other part of the red light LR toward the +D1 side.

The light modulator 183 is provided in the optical path of the red light LR output from the light-incident-side polarizer 173, and is disposed at a position shifted toward the −D1 side from the light-incident-side polarizer 173 and where the light modulator 183 overlaps with the light-incident-side polarizer 173 in the D2 and D3 directions. The light modulator 183 corresponds to a third light modulator, and modulates the red light LR output from the light-incident-side polarizer 173 based on image information input from the image formation apparatus that is not shown but is externally coupled to the light modulator 183, such as a computer.

The light modulator 183 is, for example, a transmissive liquid crystal panel. The liquid crystal panel constituting the light modulator 183 includes multiple pixels that are not shown. The pixels each include a switching element. The switching element is, for example, a TFT. An electric signal according to the brightness of the red light at the relative position of each of the pixels at the light modulation surface of the light modulator 183 in an image projected by the projector 301 is supplied to the switching element in the pixel. The pixels each modulate the vibration direction of the red light LR incident from the light-incident-side polarizer 173 with the aid of the operation of the switching element according to the electric signal described above to generate red image light IR. The image light IR corresponds to the third light. The light modulator 183 outputs the image light IR generated by the liquid crystal panel toward the −D1 side along the D1 direction.

The light-exiting-side polarizer 177 is provided in the optical path of the image light IR output from the light modulator 183, and is disposed at a position shifted toward the −D1 side from the light modulator 183 and where the light-exiting-side polarizer 177 overlaps with the light modulator 183 in the D2 and D3 directions. The light-exiting-side polarizer 177 is in contact, for example, with the −D1 side of the light modulator 183, and may instead be disposed at an appropriate distance from the light modulator 183 in the D1 direction. The light-exiting-side polarizer 177 corresponds to a sixth polarizer, and outputs predetermined polarized light out of the image light IR output from the light modulator 183 toward the −D1 side along the D1 direction. The predetermined polarized light corresponds to a sixth polarized component, and is, for example, P-polarized light.

The light-exiting-side polarizer 177 is, for example, a reflective or absorptive polarizing plate having plate surfaces parallel to the plane containing the D2 and D3 directions. When it is desired to suppress return light and stray light directed to the light modulator 183, it is desirable to employ an absorptive polarizing plate as the light-exiting-side polarizer 177. The light-exiting-side polarizer 177 transmits part of the incident image light IR that contains the predetermined polarized light toward the −D1 side, and absorbs or reflects the other part of the image light IR toward the +D1 side.

The light combiner 200 is disposed in a region where the optical path of the blue image light IB output from the light-exiting-side polarizer 175, the optical path of the green image light IG output from the light-exiting-side polarizer 176, and the optical path of the red image light IR output from the light-exiting-side polarizer 177 intersect with one another. The light combiner 200 combines the image light IB, the image light IG, and the image light IR output from the light-exiting-side polarizers 175, 176, and 177 with one another, and outputs thus generated image light IM toward the +D2 side along the D2 direction.

The light combiner 200 is, for example, a cross dichroic prism 210. The cross dichroic prism 210 has a light incident surface 210c facing the light exiting surface of the light-exiting-side polarizer 175, a light incident surface 210d facing the light exiting surface of the light-exiting-side polarizer 176, a light incident surface 210e facing the light exiting surface of the light-exiting-side polarizer 177, a light exiting surface 210b, and two reflection films 211 and 212. The light incident surfaces 210c and 210e are parallel to the plane containing the D2 and D3 directions, and coincide with each other in the D2 and D3 directions. The light incident surface 210d and the light exiting surface 210b are parallel to the plane containing the D1 and D3 directions, and coincide with each other in the D1 and D3 directions.

The reflection film 211 is disposed so as to extend from the +D2 side toward the −D2 side as extending from the −D1 side toward the +D1 side when viewed along the D3 direction. The reflection film 212 is disposed so as to extend from the −D2 side toward the +D2 side as extending from the −D1 side toward the +D1 side when viewed along the D3 direction. The reflection films 211 and 212 overlap with the light incident surfaces 210c and 210e in the D2 direction, overlap with the light incident surface 210d and the light exiting surface 210b in the D1 direction, and overlap with the light incident surfaces 210c, 210d, and 210e and the light exiting surface 210b in the D3 direction. The reflection film 211 reflects light having the red wavelength band and transmits light having the blue wavelength band and the green wavelength band. The reflection film 212 reflects light having the blue wavelength band and transmits light having the green wavelength band and the red wavelength band.

The cross dichroic prism 210 is so configured that, when viewed in the D3 direction, four rectangular prisms are glued to each other along the right angle forming surfaces with the right-angle vertices positioned at the center of the light combiner 200. The four rectangular prisms of the cross dichroic prism 210 are made of a transparent material that transmits light having the visible wavelength band. The reflection film 211 is disposed at the right angle forming surface that extends from the +D2 side toward the −D2 side as extending from the −D1 side toward the +D1 side as described above out of the right angle forming surfaces of the four rectangular prisms, and is configured, for example, with a dielectric multilayer film. The reflection film 212 is disposed at the right angle forming surface that extends from the −D2 side toward the +D2 side as extending from the −D1 side toward the +D1 side as described above out of the right angle forming surfaces of the four rectangular prisms, and is configured, for example, with a dielectric multilayer film.

The P-polarized blue image light IB output from the light-exiting-side polarizer 175 enters the interior of the cross dichroic prism 210 via the light incident surface 210c toward the +D1 side along the D1 direction, passes through the reflection film 211, is reflected off the reflection film 212, and travels toward the +D2 side. The P-polarized green image light IG output from the light-exiting-side polarizer 176 enters the interior of the cross dichroic prism 210 via the light incident surface 210d toward the +D2 side along the D2 direction, passes through the reflection films 211 and 212, and travels straight toward the +D2 side. The P-polarized red image light IR output from the light-exiting-side polarizer 177 enters the interior of the cross dichroic prism 210 via the light incident surface 210e toward the −D1 side along the D1 direction, passes through the reflection film 212, is reflected off the reflection film 211, and travels toward the +D2 side. The image light IB, the image light IG, and the image light IR output from the reflection films 211 and 212 of the cross dichroic prism 210 toward the +D2 side are combined with one another to generate the full-color image light IM. The cross dichroic prism 210 outputs the full-color image light IM via the light exiting surface 210b toward the +D2 side along the D2 direction.

The projection system 250 is disposed in the optical path of the image light IM output from the light combiner 200. The projection system 250 projects the image light IM onto a screen SCR disposed at a position shifted toward the +D2 side from the projection system 250, enlarges images input from the image formation apparatus to the light modulators 181, 182, and 183, and displays the enlarged images on the screen SCR.

The projection system 250 is configured, for example, with one or more optical lenses arranged along the D2 direction. Examples of the optical lenses may include a plano-convex lens, a plano-concave lens, a biconvex lens, a biconcave lens, a meniscus lens, an aspherical lens, and a freeform lens.

The configurations of the blue light outputting section 101, the green light outputting section 102, and the red light outputting section 103 will next be partly described in detail.

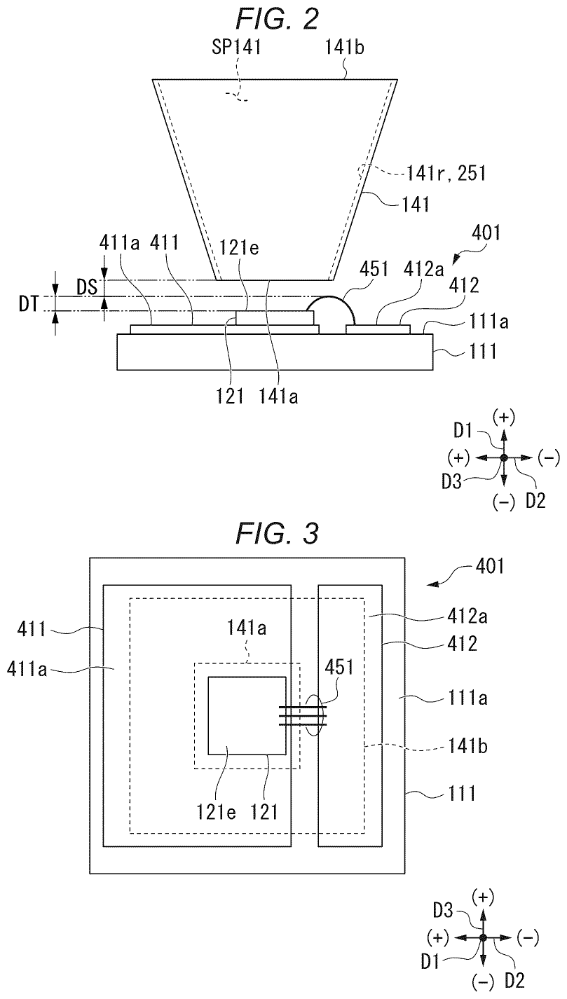

FIG. 2 is a side view of the light source 401 and the light guide 141 of the blue light outputting section 101 in the projector 301 according to the present embodiment. FIG. 3 is a plan view of the light source 401 and the light guide 141 of the blue light outputting section 101 in the projector 301 according to the present embodiment, the plan view viewed along the D2 direction from the +D2 side toward the −D2 side.

In the light source 401, a +D1-side plate surface 111a of the substrate 111 is parallel to the plane containing the directions D2 and D3 as described above, as shown in FIGS. 2 and 3. Electrodes 411 and 412 are provided at the plate surface 111a of the substrate 111. The electrodes 411 and 412 are disposed in different regions of the plate surface 111a. The number and the shapes of the electrodes provided at the plate surface 111a of the substrate 111 are not limited to a specific number and specific shapes, and are appropriately set in accordance with the specifications, the shape, and other factors of the light emitting device 121. FIGS. 2 and 3 show two electrodes 411 and 412 by way of example. The electrodes including the electrodes 411 and 412 and provided at the plate surface 111a are part of the base of the light source 401. The electrodes 411 and 412 are formed at the plate surface 111a, for example, by a printing-based fine electrode patterning technology.

For example, the light emitting device 121 is disposed at a +D1-side surface 411a of the electrode 411 and electrically coupled to the electrode 411. The light emitting device 121 and the electrode 412 are electrically coupled to each other by electrically conducting lines 451 and are coupled to each other, for example, by wire bonding. The electrically conducting lines 451 correspond to a first electrically conducting line, and are, for example, wires formed by wire bonding. The electrically conducting lines 451 supply the light emitting device 121 with electric power based on a desired voltage or current supplied from a power supply that is not shown but is electrically coupled to the electrodes 411 and 412.

The electrically conducting lines 451 couple a +D1-side light emission surface 121e of the light emitting device 121 and a +D1-side surface 412a of the electrode 412 to each other, and protrude and curve toward the +D1 side beyond the light emission surface 121e and the surface 412a. The number and arrangement of the electrically conducting lines 451 in the light source 401 are appropriately set in accordance with the specifications and shape of the light emitting device 121, the relative positional relationship between the light emitting device 121 and the electrodes, the number and shapes of the electrodes, and other factors. FIGS. 2 and 3 show three electrically conducting lines 451 by way of example.

The light emission surface 121e of the light emitting device 121 is shifted toward the +D1 side from the surface 412a of the electrode 412. The +D1 side end of each of the electrically conducting lines 451 is shifted toward the +D1 side from the light emission surface 121e of the light emitting device 121. A distance DT between the +D1-side end of the electrically conducting lines 451 and the light emission surface 121e in the D1 direction, that is, the direction parallel to the optical axis of the blue light LB emitted from the light emitting device 121 is greater than or equal to 0.0 mm but smaller than 0.7 mm.

In the blue light outputting section 101, a distance DS between the +D1-side end of one or more of the electrically conducting lines 451 and the −D1-side light incident end 141a of the light guide 141 in the D1 direction is at least smaller than the distance DT and is greater than or equal to 0.0 mm but smaller than or equal to 0.7 mm. The distance DS in the blue light outputting section 101 corresponds to a first distance. In detail, the distances DT and DS are positive when the light incident end 141a of the light guide 141 is shifted toward the +D1 side with respect to the light emission surface 121e of the light emitting device 121, while being negative when the light incident end 141a is shifted toward the −D1 side with respect to the light emission surface 121e. That is, the distance DS is greater than or equal to −0.7 mm but smaller than or equal to +0.7 mm, and the absolute value of the distance DS is greater than or equal to 0.0 mm but smaller than or equal to 0.7 mm. In the configuration of the blue light outputting section 101 shown in FIGS. 1 and 2 by way of example, the distance DS is greater than 0.0 mm but smaller than or equal to +0.7 mm.

In the blue light outputting section 101, the distance DS is greater than 0.0 mm but smaller than or equal to +0.7 mm in the portion facing the light incident end 141a of the light guide 141 that faces the electrically conducting lines 451 in the D1 direction. The portion facing the light incident end 141a that faces the electrically conducting lines 451 in the D1 direction is a portion that is shifted toward the +D1 side from the electrically conducting lines 451 and overlaps with the electrically conducting lines 451 in the directions D2 and D3. When the distance DS is greater than +0.7 mm, contact between the light guide 141 and the electrically conducting lines 451 is avoided, but there is a possibility of insufficient efficiency of use of the blue light LB emitted from the light emitting device 121 and introduced into the light guide 141. When the distance DS is smaller than −0.7 mm, there is a possibility of insufficiently homogenized illuminance distribution of the blue light LB at the light exiting end 141b of the light guide 141.

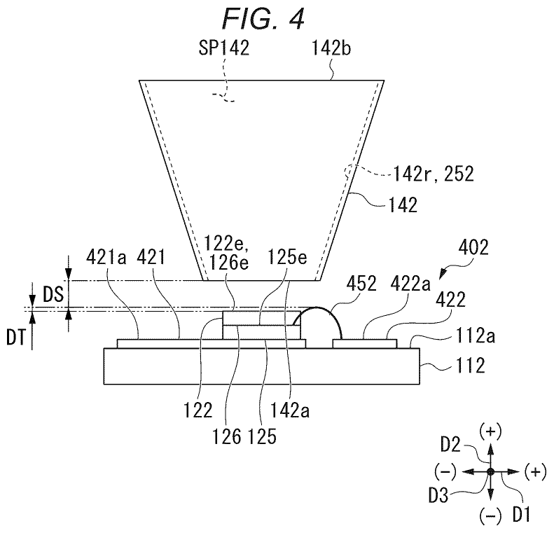

FIG. 4 is a side view of the light source 402 and the light guide 142 of the green light outputting section 102 in the projector 301 according to the present embodiment. The green light outputting section 102 is configured in the same manner as the blue light outputting section 101 except for the configuration of the light emitting device.

Electrodes 421 and 422 are provided at a +D2-side plate surface 112a of the substrate 112 in the light source 402, as shown in FIG. 4. The electrodes 421 and 422 are disposed in different regions of the plate surface 112a. The number and the shapes of the electrodes provided at the plate surface 112a of the substrate 112 are not limited to a specific number and specific shapes, and are appropriately set in accordance with the specifications, the shape, and other factors of the light emitting device 122. FIG. 4 shows two electrodes 421 and 422 by way of example. The electrodes including the electrodes 421 and 422 and provided at the plate surface 112a are part of the base of the light source 402. The electrodes 421 and 422 are formed at the plate surface 112a, for example, by a printing-based fine electrode patterning technology.

The light emitting device 122 is disposed, for example, at a +D2-side surface 421a of the electrode 421. The light emitting device 122 includes a light emitter 125 and a phosphor 126. The light emitter 125 has a light emission surface 125e, via which excitation light exits toward the +D2 side. The light emission surface 125e is a +D2-side surface of the light emitter 125 that is parallel to the plane containing the D1 and D3 directions. The excitation light output from the light emitter 125 is, for example, blue light having the blue wavelength band.

The light emitter 125 is electrically coupled to the electrode 421. The light emitter 125 of the light emitting device 122 and the electrode 422 are electrically coupled to each other via electrically conducting lines 452 and are coupled to each other, for example, by wire bonding. The electrically conducting lines 452 correspond to a second electrically conducting line, and are, for example, wires formed by wire bonding. The electrically conducting lines 452 supply the light emitter 125 of the light emitting device 122 with electric power based on a desired voltage or current supplied from a power supply that is not shown but is electrically coupled to the electrodes 421 and 422.

The electrically conducting lines 452 couple the +D2-side light emission surface 125e of the light emitter 125 and a +D2-side surface 422a of the electrode 422 to each other, and protrude and curve toward the +D2 side beyond the light emission surface 125e and the surface 422a. The number and arrangement of the electrically conducting lines 452 in the light source 402 are appropriately set in accordance with the specifications and shape of the light emitter 125 of the light emitting device 122, the relative positional relationship between the light emitter 125 and the electrodes, the number and shapes of the electrodes, and other factors.

The phosphor 126 is disposed on the +D2 side of the light emitter 125, and overlaps with the light emitter 125 in the D1 and D3 directions. For example, the phosphor 126 is layered on the +D2 side of the light emitter 125. The phosphor 126 is excited by the excitation light emitted from the light emitter 125, and emits the green light LG as fluorescence via a light emission surface 126e. The type and material of the phosphor 126 are appropriately so selected that the phosphor 126 excited by the excitation light emitted from the light emitter 125 emits the green light LG having the green wavelength band. The phosphor 126, which is excited by the excitation light having the blue wavelength band to emit the green light LG, is, for example, a ceramic phosphor into which phosphor particles are sintered, and is a YAG (yttrium aluminum garnet) phosphor containing cerium (Ce) ions.

The phosphor 126 emits the green light LG via the +D2-side surface parallel to the D1 and D3 directions, the side surfaces parallel to the D1 and D2 directions, and the side surfaces parallel to the D2 and D3 directions. In the green light outputting section 102, since the size of the phosphor 126 in the D1 and D3 directions is greater than the thickness of the phosphor 126 in the D2 direction, the +D2-side surface of the phosphor 126 that is parallel to the D1 and D3 directions is regarded as the light emission surface 126e of the phosphor 126. The light emission surface 126e of the phosphor 126 constitutes the light emission surface 122e of the light emitting device 122.

The light emission surface 125e of the light emitter 125 of the light emitting device 122 is located at a position shifted toward the +D2 side from the surface 422a of the electrode 422. The light emission surface 122e of the light emitting device 122 is further shifted toward the +D2 side from the light emission surface 125e of the light emitter 125. The +D2-side end of the electrically conducting lines 452 is shifted toward the +D2 side from the light emission surface 125e of the light emitter 125, and is shifted, for example, toward the +D2 side from the light emission surface 121e of the light emitting device 121. The distance DT between the +D2-side end of the electrically conducting lines 452 and the light emission surface 122e in the D2 direction, that is, the direction parallel to the optical axis of the green light LG emitted from the light emitting device 122 is greater than or equal to 0.0 mm but smaller than 0.7 mm, and may be smaller than the distance DT in the blue light outputting section 101.

In the green light outputting section 102, the distance DS between the +D2-side end of one or more of the electrically conducting lines 452 and the −D2-side light incident end 142a of the light guide 142 in the D2 direction is at least smaller than the distance DT and is greater than or equal to 0.0 mm but smaller than or equal to 0.7 mm. The distance DS in the green light outputting section 102 corresponds to a second distance. In detail, the distances DT and DS are positive when the light incident end 142a of the light guide 142 is shifted toward the +D2 side with respect to the light emission surface 122e of the light emitting device 122, while being negative when the light incident end 142a is shifted toward the −D2 side with respect to the light emission surface 122e. In the configuration of the green light outputting section 102 shown in FIGS. 1 and 4 by way of example, the distance DS is greater than 0.0 mm but smaller than or equal to +0.7 mm. When the distance DS is greater than +0.7 mm, there is a possibility of insufficient efficiency of use of the green light LG emitted from the light emitting device 122 and introduced into the light guide 142. When the distance DS is smaller than −0.7 mm, there is a possibility of insufficiently homogenized illuminance distribution of the green light LG at the light exiting end 142b of the light guide 142.

In the green light outputting section 102, the distance DS is greater than 0.0 mm but smaller than or equal to +0.7 mm in the portion facing the light incident end 142a of the light guide 142 that faces the electrically conducting lines 452 in the D2 direction. The portion facing the light incident end 142a that faces the electrically conducting lines 452 in the D2 direction is a portion that is shifted toward the +D2 side from the electrically conducting lines 452 and overlaps with the electrically conducting lines 452 in the directions D1 and D3.

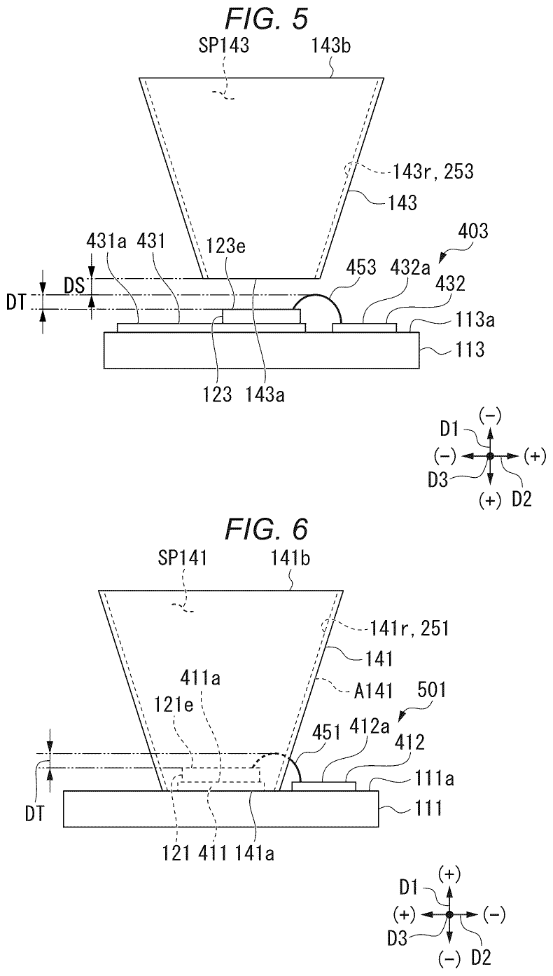

FIG. 5 is a side view of the light source 403 and the light guide 143 of the red light outputting section 103 in the projector 301 according to the present embodiment. The red light outputting section 103 is configured in the same manner as the blue light outputting section 101.

Electrodes 431 and 432 are provided at a −D1-side plate surface 113a of the substrate 113 in the light source 403, as shown in FIG. 5. The electrodes 431 and 432 are disposed in different regions of the plate surface 113a. The number and the shapes of the electrodes provided at the plate surface 113a of the substrate 113 are not limited to a specific number and specific shapes, and are appropriately set in accordance with the specifications, the shape, and other factors of the light emitting device 123. FIG. 5 shows two electrodes 431 and 432 by way of example. The electrodes including the electrodes 431 and 432 and provided at the plate surface 113a are part of the base of the light source 403. The electrodes 431 and 432 are formed at the plate surface 113a, for example, by a printing-based fine electrode patterning technology.

The light emitting device 123 is disposed, for example, at a −D1-side surface 431a of the electrode 431, and is electrically coupled to the electrode 431. The light emitting device 123 and the electrode 432 are electrically coupled to each other by electrically conducting lines 453 and are coupled to each other, for example, by wire bonding. The electrically conducting lines 453 correspond to a third electrically conducting line, and are, for example, wires formed by wire bonding. The electrically conducting lines 453 supply the light emitting device 123 with electric power based on a desired voltage or current supplied from a power supply that is not shown but is electrically coupled to the electrodes 431 and 432.

The electrically conducting lines 453 couple a −D1-side light emission surface 123e of the light emitting device 123 and a −D1-side surface 432a of the electrode 432 to each other, and protrude and curve toward the +D1 side beyond the light emission surface 123e and the surface 432a. The number and arrangement of the electrically conducting lines 453 in the light source 403 are appropriately set in accordance with the specifications and shape of the light emitting device 123, the relative positional relationship between the light emitting device 123 and the electrodes, the number and shapes of the electrodes, and other factors.

The light emission surface 123e of the light emitting device 123 is shifted toward the −D1 side from the surface 432a of the electrode 432. The −D1 side end of the electrically conducting lines 453 is shifted toward the −D1 side from the light emission surface 123e of the light emitting device 123. The distance DT between the −D1-side end of the electrically conducting lines 453 and the light emission surface 123e in the D1 direction, that is, the direction parallel to the optical axis of the red light LR emitted from the light emitting device 123 is greater than or equal to 0.0 mm but smaller than 0.7 mm.

In the red light outputting section 103, the distance DS between the −D1-side end of one or more of the electrically conducting lines 453 and the +D1-side light incident end 143a of the light guide 143 in the D1 direction is at least smaller than the distance DT and is greater than or equal to 0.0 mm but smaller than or equal to 0.7 mm. The distance DS in the red light outputting section 103 corresponds to a third distance. In detail, the distances DT and DS are positive when the light incident end 143a of the light guide 143 is shifted toward the −D1 side with respect to the light emission surface 123e of the light emitting device 123, and while being negative when the light incident end 143a is shifted toward the +D1 side with respect to the light emission surface 123e. In the configuration of the red light outputting section 103 shown in FIG. 5 by way of example, the distance DS is greater than 0.0 mm but smaller than or equal to +0.7 mm. When the distance DS is greater than +0.7 mm, there is a possibility of insufficient efficiency of use of the red light LR emitted from the light emitting device 123 and introduced into the light guide 143. When the distance DS is smaller than −0.7 mm, there is a possibility of insufficiently homogenized illuminance distribution of the red light LR at the light exiting end 143b of the light guide 143.

In the red light outputting section 103, the distance DS is greater than 0.0 mm but smaller than or equal to +0.7 mm in the portion facing the light incident end 143a of the light guide 143 that faces the electrically conducting lines 453 in the D1 direction. The portion facing the light incident end 143a that faces the electrically conducting lines 453 in the D1 direction is a portion that is shifted toward the −D1 side from the electrically conducting lines 453 and overlaps with the electrically conducting lines 453 in the directions D2 and D3.

In the projector 301 according to the present embodiment, the light emitting device 122 of the green light outputting section 102 includes the light emitter 125 and the phosphor 126, and at least one of the light emitting device 121 of the blue light outputting section 101 and the light emitting device 123 of the red light outputting section 103 may include a light emitter that radiates excitation light and a phosphor excited by the excitation light to emit color light. Instead, the light emitting device 122 of the green light outputting section 102 may not include a phosphor but include only a light emitter such as an LED.

Setting the absolute value of the distance DS at 0.7 mm or smaller in the present embodiment can preferably suppress a decrease in light use efficiency, and prevent disconnection of the wires that couple the light emitting device to the electrode in each of the light sources and a short circuit in the light source. Note that setting the absolute value of the distance DS at 0.5 mm or smaller can provide light use efficiency of 80% or higher. It is therefore more preferable that the absolute value of the distance DS is set at 0.5 mm or smaller. The dimension of 0.7 mm or 0.5 mm presented as the preferable upper limit of the absolute value of the distance DS by way of example is calculated by numerical calculation in consideration of the dimensions and relative arrangement of the light source and the light guide in each of the color light outputting sections.

The projector 301 according to the present embodiment described above includes the light source (first light source) 401, the light guide (first light guide) 141, the parallelizing element (first parallelizing element) 161, the light modulator (first light modulator) 181, and the projection system 250. The light source 401 includes the light emitting device (first light emitting device) 121, the electrically conducting lines (first electrically conducting line) 451, and the substrate (base) 111. The light emitting device 121 outputs the blue light (first light) LB having the blue wavelength band (first wavelength band). The electrically conducting lines 451 supply the light emitting device 121 with electric power. The substrate 111 and the electrodes (base) 411 and 412 support the light emitting device 121 and the electrically conducting lines 451 from the −D1 side. The light guide 141 has the light incident end (first light incident end) 141a and the light exiting end (first light exiting end) 141b, and homogenizes the illuminance of the incident blue light LB in the plane containing the D2 and D3 directions (in-plane illuminance). The blue light LB output from the light source 401 is incident on the light incident end 141a and enters the light guide 141 via the light incident end 141a. The blue light LB guided in the light guide 141 toward the +D1 side in the D1 direction exits via the light exiting end 141b. That is, the light exiting end 141b causes the blue light LB to exit. The parallelizing element 161 parallelizes the blue light LB output from the light guide 141. The light modulator 181 modulates the blue light LB output from the parallelizing element 161 based on image information. The projection system 250 projects the image light (light) IB output from the light modulator 181. In the projector 301 according to the present embodiment, the light guide 141 is disposed away from the electrically conducting lines 451 in the light source 401 in the D1 direction. In the projector 301 according to the present embodiment, the distance (first distance) DS between the light incident end 141a of the light guide 141 and the light emission surface 121e of the light emitting device 121 of the light source 401 is greater than or equal to −0.7 mm but smaller than or equal to 0.7 mm, specifically, greater than 0.0 mm but smaller than or equal to +0.7 mm.

In the projector 301 according to the present embodiment, the light incident end 141a of the light guide 141 and the light emission surface 121e of the light emitting device 121 of the light source 401 are separate from each other by an appropriate distance in the D1 direction, so that contact between the light guide 141 and the electrically conducting lines 451 is avoided, and a short circuit or disconnection in the light source 401 is avoided. In addition, the configuration in which the light incident end 141a of the light guide 141 and the light emission surface 121e of the light emitting device 121 of the light source 401 are separate from each other by an appropriate distance in the D1 direction suppresses the amount of the blue light LB that is output from the light source 401 but leaks via a portion outside the light incident end 141a of the light guide 141 in the plane containing the D2 and D3 directions, and therefore ensures a certain amount of the blue light LB introduced into the light guide 141 via the light incident end 141a. The projector 301 according to the present embodiment can therefore prevent disconnection of the electrically conducting lines 451, which couple the light emitting device 121 to the electrode 412 in the light source 401, and a short circuit in the light source 401 while suppressing a decrease in the light use efficiency.

In the projector 301 according to the present embodiment, the cross-sectional shape of the light guide 141 that intersects with the D1 direction, that is, the shape of the light guide 141 in the plane containing the D2 and D3 directions is a quadrangular shape.

The projector 301 according to the present embodiment, in which the blue light LB having a quadrangular shape and a homogenized illuminance distribution in the plane containing the D2 and D3 directions exits via the light exiting end 141b of the light guide 141, can readily generate illumination light having a quadrangular shape and a homogenized illuminance distribution.

In the projector 301 according to the present embodiment, the green light outputting section 102 and the red light outputting section 103 are configured in the same manner as the blue light outputting section 101. The projector 301 according to the present embodiment further includes the light source (second light source) 402, the light source (third light source) 403, the light guide (second light guide) 142, the light guide (third light guide) 143, the parallelizing element (second parallelizing element) 162, the parallelizing element (third parallelizing element) 163, the light modulator (second light modulator) 182, and the light modulator (third light modulator) 183.

The light source 402 includes the light emitting device (second light emitting device) 122, the electrically conducting lines (second electrically conducting lines) 452, and the substrate (base) 112. The light emitting device 122 outputs the green light (second light) LG having the green wavelength band (second wavelength band). The electrically conducting lines 452 supply the light emitting device 122 with electric power. The substrate 112 and the electrodes (base) 421 and 422 support the light emitting device 122 and the electrically conducting lines 452 from the −D2 side. The light guide 142 has the light incident end (second light incident end) 142a and the light exiting end (second light exiting end) 142b, and homogenizes the illuminance of the incident green light LG in planes containing the D1 and D3 directions (in-plane illuminance). The green light LG output from the light source 402 is incident on the light incident end 142a and enters the light guide 142 via the light incident end 142a. The green light LG guided in the light guide 142 toward the +D2 side in the D2 direction exits via the light exiting end 142b. That is, the light exiting end 142b causes the green light LG to exit. The parallelizing element 162 parallelizes the green light LG output from the light guide 142. The light modulator 182 modulates the green light LG output from the parallelizing element 162 based on image information.

The light source 403 includes the light emitting device (third light emitting device) 123, the electrically conducting lines (third electrically conducting lines) 453, and the substrate (base) 113. The light emitting device 123 outputs the red light (third light) LR having the red wavelength band (third wavelength band). The electrically conducting lines 453 supply the light emitting device 123 with electric power. The substrate 113 and the electrodes (base) 431 and 432 support the light emitting device 123 and the electrically conducting lines 453 from the +D1 side. The light guide 143 has the light incident end (third light incident end) 143a and the light exiting end (third light exiting end) 143b, and homogenizes the illuminance of the incident red light LR in the plane containing the D2 and D3 directions (in-plane illuminance). The red light LR output from the light source 403 is incident on the light incident end 143a and enters the light guide 143 via the light incident end 143a. The red light LR guided in the light guide 143 toward the −D1 side in the D1 direction exits via the light exiting end 143b. That is, the light exiting end 143b causes the red light LR to exit. The parallelizing element 163 parallelizes the red light LR output from the light guide 143. The light modulator 183 modulates the red light LR output from the parallelizing element 163 based on image information. The projection system 250 projects the image light (light) IB, IG, and IR output from the light modulators 181, 182, and 183, respectively.

The three-plate projector 301 according to the present embodiment can prevent the disconnection of the electrically conducting lines 451, 452, and 453 and short circuits in the light sources 401, 402, and 403 while suppressing a decrease in light use efficiency in each of the color light outputting sections, which output the multiple types of light having the three primary colors.

A first variation of the present embodiment will next be described. In the following variations, elements common to those of the blue light outputting section 101, the green light outputting section 102, and the red light outputting section 103 of the projector 301 according to the embodiment described above have the same reference characters, and only the contents different from the configurations of the color light outputting sections will be described. In each of the variations, one of the blue light outputting section 101, the green light outputting section 102, and the red light outputting section 103 is shown by way of example, and configurations common to those of the color light outputting sections will be described.

### First Variation

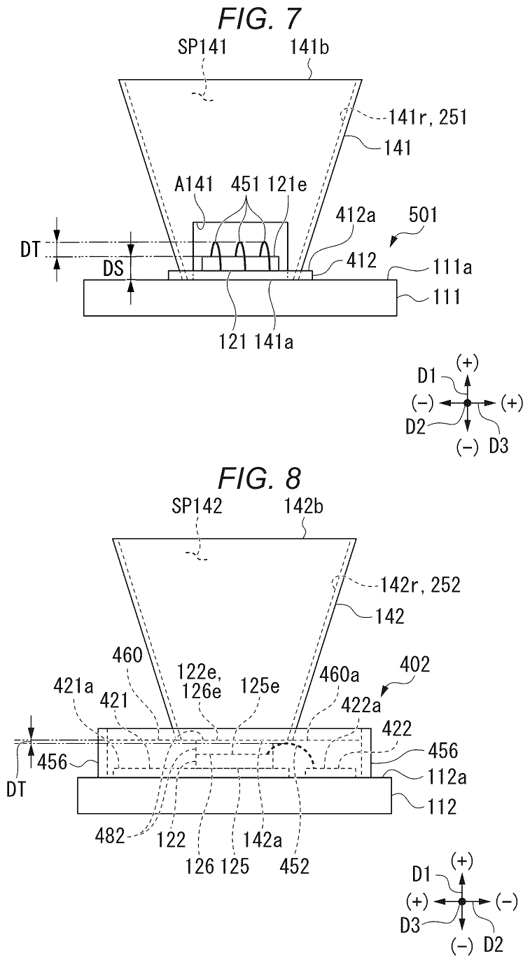

FIG. 6 is a side view of the light source 401 and the light guide 141 of a blue light outputting section 501 according to a first variation of the present embodiment, the side view viewed along the D3 direction. FIG. 7 is a side view of the light source 401 and the light guide 141 of the blue light outputting section 501, the side view viewed along the D2 direction.

In the blue light outputting section 501, when viewed along the D1 direction, the electrode 411 overlaps the light emitting device 121 in a plane containing the D2 and D3 directions, and has a shape and a size that are substantially the same as those of the light emitting device 121, as shown in FIGS. 6 and 7. The total height of the electrode 411 and the light emitting device 121 in the D1 direction is smaller than or equal to 0.7 mm. The electrode 412 is disposed at a position shifted toward the −D2 side from the electrode 411.

In the blue light outputting section 501, a cutout A141 is formed in a sidewall having the side surface 141s that overlaps with the region occupied by the electrically conducting lines 451 in the D1 direction out of the four side surfaces 141s of the light guide 141. The cutout A141 is an opening starting from the light incident end 141a of the light guide 141, is recessed in the D1 direction from the position of the light incident end 141a, which is the −D1-side end position thereof, toward the +D1 side to the depth equal to the distance DS. That is, in the blue light outputting section 501, the cutout A141 is formed at a location where the cutout A141 faces the electrically conducting lines 451 at the light incident end 141a of the light guide 141.

Since the depth of the cutout A141 in the D1 direction is equal to the distance DS, the portion of the light incident end 141a that does not face the electrically conducting lines 451 is in contact with the +D1-side plate surface 111a of the substrate 111. The portion of the light incident end 141a that does not face the electrically conducting lines 451 is disposed below the plate surface 111a at a depth deeper than 0 mm but shallower than −0.7 mm. When viewed along the D1 direction, the electrode 411 overlaps with the light incident end 141a of the light guide 141, is contained in the light incident end 141a, and is surrounded by the sidewalls of the light guide 141. When viewed along the D1 direction, the cutout A141 intersects with the electrically conducting lines 451. The electrically conducting lines 451 pass through the cutout A141 along the D2 direction.

The depth of the cutout A141 in the D1 direction is equal to the distance DS, is greater than or equal to 0.1 mm but smaller than or equal to 0.7 mm, preferably, greater than or equal to 0.3 mm but smaller than or equal to 0.7 mm. The size or width of the cutout A141 in the D3 direction is greater than the region occupied by one or more electrically conducting lines 451 in the D3 direction by a value greater than 0 mm but smaller than or equal to 0.7 mm toward the −D3 and +D3 sides. The plate-shaped member that forms a sidewall of the light guide 141 and faces the electrically conducting lines 451 is thus separate from the electrically conducting lines 451.

The projector according to the first variation of the present embodiment described above can provide the same advantages and effects provided by the configurations common to those of the projector according to the present embodiment.

In the projector according to the first variation of the present embodiment, the light guide 141 is in contact with the light source 401 while being separate from the electrically conducting lines 451. That is, a portion of the light incident end 141a of the light guide 141 of the blue light outputting section 501 is separate from the electrically conducting lines 451, and the substrate 111 and the base other than the substrate 111 of the light source 401, and the remainder of the light incident end 141a is in contact with the substrate 111.

In the projector according to the first variation of the present embodiment, the distance DS in the D1 direction between the light incident end 141a other than the portion where the cutout A141 is formed at the light incident end 141a of the light guide 141 and the light emission surface 121e of the light emitting device 121 of the light source 401 is greater than or equal to −0.7 mm but smaller than 0 mm. In the projector according to the first variation of the present embodiment, the shortest distance DS between the light incident end 141a of the light guide 141 and the light emission surface 121e of the light emitting device 121 is shorter than that in the projector 301 according to the present embodiment, so that the blue light LB emitted from the light emitting device 121 of the light source 401 can be introduced into the light guide 141 at increased efficiency.

In the projector according to the first variation of the present embodiment, the cutout A141 is formed at a portion of (position at) the light guide 141 where the cutout A141 faces the electrically conducting lines 451. The electrically conducting lines 451 are inserted into the region inside (interior of) the light incident end 141a through the cutout A141 from the region above the substrate 111 outside the light incident end 141a (exterior thereof) in the D2 and D3 directions.

In the projector according to the first variation of the present embodiment, the cutout A141 prevents contact between the light guide 141 and the electrically conducting lines 451, and minimizes a decrease in the light guide 141 around the light emitting device in the light source 401 and the amount of the blue light LB that leaks via a portion outside the light incident end 141a of the light guide 141. The projector according to the first variation of the first embodiment allows the blue light LB output from the light emitting device 121 to be introduced into the light guide 141 at increased efficiency.

In the projector according to the first variation of the present embodiment, the dimension of the cutout A141 in the direction in which the blue light LB from the light source 401 exits, that is, the D1 direction is greater than or equal to 0.1 mm but smaller than or equal to 0.7 mm.

In the projector according to the first variation of the present embodiment, to avoid contact with the electrically conducting lines 451, the dimension of the cutout A141 can be minimized, and the loss of the blue light LB can be minimized.

Although not shown, as long as the portion of the light incident end 141a of the plate-shaped members of the light guide 141 that extends in parallel to the D3 direction and corresponds to the cutout A141 is separate from the electrically conducting lines 451 as described above, the portion of the light incident end 141a of the plate-shaped members of the light guide 141 where the cutout A141 is not formed may be separate from the plate surface 111a of the substrate 111 and may be shifted toward the +D1 side from the plate surface 111a. In this case, the depth of the cutout A141 in the D1 direction may be the distance DS from which the distance in the D1 direction between the plate surface 111a and the portion of the light incident end 141a where the cutout A141 is not formed is subtracted.

Furthermore, a through hole that is not open toward the −D1 side, unlike the cutout A141, may be formed in the portion of the plate-shaped members of the light guide 141 that faces the electrically conducting lines 451 in place of the cutout A141. Also in this case, the electrically conducting lines 451 pass through the through hole along the D3 direction, and couples the light emitting device 121 and the electrode 412 to each other.

In the projector according to the first variation of the present embodiment, when a cutout is formed in each of the green and red light outputting sections, as the cutout A141 formed in the light guide 141 of the blue light outputting section 501, the same advantages and effects provided by the blue light outputting section 501 can be provided by the green and red light outputting sections.

Note that all of the light emitting device 121, the electrodes 411 and 412, and the one or more electrically conducting lines 451 may be surrounded by the light incident end 141a of the light guide 141 and may not be in contact with the light incident end 141a in the blue light outputting section 501 when viewed along the D1 direction. In this case, the cutout A141 may not be formed in the light guide 141. In this case as well, the light guide 141 is in contact with the substrate 111 of the light source 401 while being separate from the electrically conducting lines 451. That is, the entire light incident end 141a of the light guide 141 of the blue light outputting section 501 is in contact with the plate surface 111a of the substrate 111.

According to the projector having the configuration described above, the distance DS between the light incident end 141a of the light guide 141 and the light emission surface 121e of the light emitting device 121 is greater than or equal to −0.7 mm but smaller than 0 mm, and is therefore appropriately ensured, as in the projector 301 according to the present embodiment, so that the blue light LB emitted from the light emitting device 121 of the light source 401 can be introduced into the light guide 141 at increased efficiency.

### Second Variation

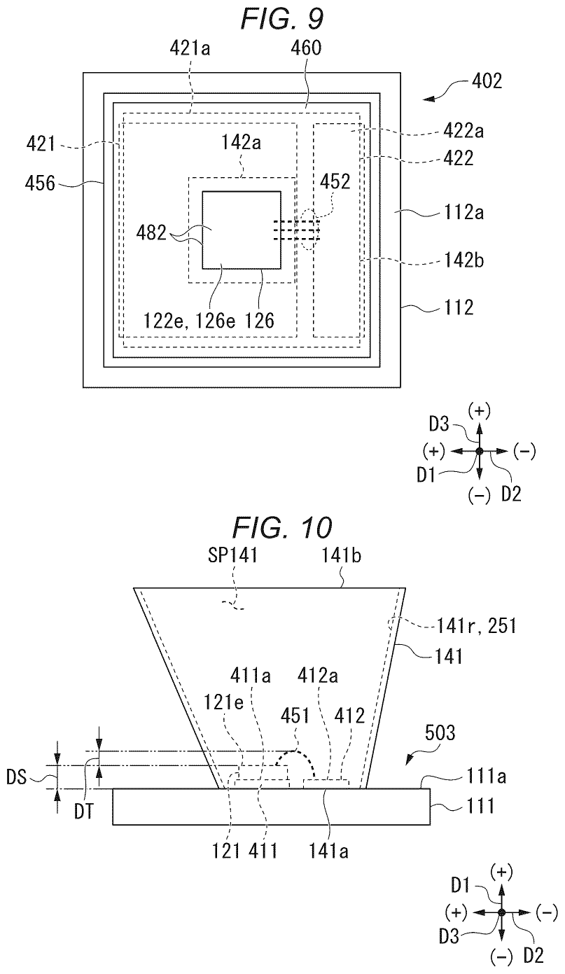

FIG. 8 is a side view of the light source 402 and the light guide 142 of a green light outputting section 502 according to a second variation of the present embodiment, the side view viewed along the D3 direction. FIG. 9 is a plan view of the light source 402 and the light guide 142 of the green light outputting section 502, the plan view viewed along the D2 direction. In the second variation of the present embodiment, the light source 402 of the green light outputting section 502 corresponds to the first light source, the light emitting device 122 corresponds to the first light emitting device, the green light LG corresponds to the first light, the electrically conducting lines 452 correspond to the first electrically conducting line, and the light guide 142 corresponds to the first light guide.

In the green light outputting section 502, a sidewall 456 is provided at an outer circumferential portion of the plate surface 112a of the substrate 112, as shown in FIGS. 8 and 9. The sidewall 456 extends from the plate surface 112a toward the +D2 side, and is formed outside the light emitting device 122, the electrodes 421 and 422 and the electrically conducting lines 452 when viewed along the D2 direction. The +D2-side end surface of the sidewall 456 is shifted toward the +D2 side from the light emission surface 122e of the light emitting device 122. A sealing member 460 is filled in the region inside the sidewall 456 and the region outside the light emitting device 122 in planes containing the D1 and D3 directions. The sealing member 460 is contained in the base of the light source 402.

The +D2-side surface of the sealing member 460 is flush with the light emission surface 122e of the light emitting device 122 in the D2 direction. The +D2-side surface and the side surfaces of each of the electrodes 421 and 422, the side surfaces of the light emitter 125, and the electrically conducting lines 452 are covered with the sealing member 460. The electrodes 421 and 422 and the electrically conducting lines 452 are embedded in the sealing member 460. The light emission surface 122e of the light emitting device 122 is exposed out of the sealing member 460. The sealing member 460 is an insulating member or an insulator and is made, for example, of resin that transmits visible light containing the blue light LB, the green light LG, and the red light LR.

In the green light outputting section 502, the light incident end 142a of the light guide 142 is in contact with the sealing member 460. The distance DS in the D2 direction between the light incident end 142a of the light guide 142 and the light emission surface 122e of the light emitting device 122 is greater than or equal to 0 mm but smaller than or equal to 0.7 mm, specifically, about 0 mm. Since the light incident end 142a is in contact with the +D2-side surface of the sealing member 460, the light guide 142 is supported by the sealing member 460 from the −D2 side.

The projector according to the second variation of the present embodiment described above can provide the same advantages and effects provided by the configurations common to those of the projector according to the present embodiment.

In the projector according to the second variation of the present embodiment, the base of the light source (first light source) 402 of the green light outputting section 102 includes the sealing member 460, which covers the electrically conducting lines (first electrically conducting line) 452. The sealing member 460 is an insulating member. The light incident end 142a of the light guide 142 is in contact with the sealing member 460 in the D2 direction.

In the projector according to the second variation of the present embodiment, the insulating sealing member 460 is interposed between the light emitting device (first light emitting device) 122 and the light guide (first light guide) 142. The projector according to the second variation of the present embodiment can more reliably prevent disconnection of the electrically conducting lines 452 and use the green light LG at increased efficiency.

In the projector according to the second variation of the present embodiment, the light source 402 includes light divergence sections 482, which cause the green light LG to diverge. The light divergence sections 482 are disposed on the +D2 side of the light emitting device 122, that is, on the side thereof via which the green light (first light) LG exits. Specifically, the light divergence sections 482 have a +D2-side end surface of the phosphor 126 of the light emitting device 122 that is parallel to the plane containing the D1 and D3 directions, that is, the light emission surface 122e, the side surfaces of the phosphor 126 that are parallel to a plane containing the D1 and D2 directions, and the side surfaces of the phosphor 126 that are parallel to the plane containing the D2 and D3 directions. The sealing member 460 supports the circumference of the light divergence sections 482 when viewed in the D2 direction. Specifically, in the planes containing the D1 and D3 directions, the sealing member 460 surrounds the side surfaces of the light emitter 125 and the phosphor 126 of the light emitting device 122, and is in contact with the side surfaces of the light emitter 125 and the phosphor 126 from the side facing the outer circumference thereof.

In the projector according to the second variation of the present embodiment, the configuration of the light divergence sections 482 can be simplified, and the light emitting device 122 and the light divergence sections 482 are supported by the sealing member 460, so that the durability of the light emitting device 122 can be enhanced. Furthermore, in the projector according to the second variation of the present embodiment, since the light emission surface 122e of the light emitting device 122 is located near the light incident end 142a of the light guide 142 in the D2 direction, the green light LG can be used at increased efficiency.

In the projector according to the second variation of the present embodiment, when the blue and red light outputting sections are configured in the same manner as the green light outputting section 502, the same advantages and effects provided by the green light outputting section 502 can be provided by the blue and red light outputting sections.

### Third Variation

FIG. 10 is a side view of the light source 401 and the light guide 141 of a blue light outputting section 503 according to a third variation of the present embodiment, the side view viewed along the D3 direction.

In the blue light outputting section 503, the entire light incident end 141a of the light guide 141 is parallel to the plate surface 111a of the substrate 111 of the light source 401 and the light emission surface 121e of the light emitting device 121, and is parallel to the plane containing the D2 and D3 directions, as shown in FIG. 10. When viewed along the D1 direction, all the electrodes including the electrodes 411 and 412, the light emitting device 121, and the electrically conducting lines 451 are surrounded by the light incident end 141a of the light guide 141.

In the blue light outputting section 503, the angles of the four side surfaces 141s of the light guide 141 with respect to an axis parallel to the D1 direction may differ from each other in accordance with the relative arrangement of the electrodes 411 and 412 at the plate surface 111a of the substrate 111. For example, the light guide 141 tapers from the light exiting end 141b toward the light incident end 141a, and when viewed along the D1 direction, the four side surfaces 141s of the light guide 141 approach the center of the plate surface 111a of the substrate 111 as the four side surfaces 141s extend from the light exiting end 141b toward the light incident end 141a. Out of the four side surfaces 141s of the light guide 141, the angles of the two side surfaces 141s facing each other in the D3 direction with respect to the axis parallel to the D1 direction are equal to each other, and the angles of the remaining two side surfaces 141s facing each other in the D2 direction with respect to the axis parallel to the D1 direction differ from each other. Out of the two side surfaces 141s facing each other in the D2 direction, the angle of the −D2-side side surface 141s with respect to the axis parallel to the D1 direction is smaller than the angle of the +D2-side side surface 141s with respect to the axis parallel to the D1 direction.

The projector according to the third variation of the present embodiment described above can provide the same advantages and effects provided by the configurations common to those of the projector according to the present embodiment.

In the projector according to the third variation of the present embodiment, in a plan view viewed along the direction in which the blue light LB from the light source 401 exits, that is, the D1 direction, the light incident end 141a of the light guide 141 includes the light emitting device 121 and the electrically conducting lines 451 in the light source 401, and surrounds the light emitting device 121 and the electrically conducting lines 451 in the light source 401.

In the projector according to the third variation of the present embodiment, the light incident end 141a of the light guide 141 has a size large enough to surround the light emitting device 121 and the electrically conducting lines 451, so that contact between the electrically conducting lines 451 and the light guide 141 can be avoided even when external impact acts on the projector and the light guide 141 therefore vibrates. The projector according to the third variation of the present embodiment can more reliably prevent disconnection of the electrically conducting lines 451 and a short circuit in the light source 401.

In the projector according to the third variation of the present embodiment, when the green and red light outputting sections are configured in the same manner as the blue light outputting section 503, the same advantages and effects provided by the blue light outputting section 503 can be provided by the green and red light outputting sections.

In the projector according to the present embodiment and the first to third variations thereof, the light guides 141, 142, and 143 are each a hollow member. The internal space SP141, which tapers from the light exiting end 141b toward the light incident end 141a, is formed in the light guide 141. The internal space SP142, which tapers from the light exiting end 142b toward the light incident end 142a, is formed in the light guide 142. The internal space SP143, which tapers from the light exiting end 143b toward the light incident end 143a, is formed in the light guide 143.

In the projector according to the present embodiment and the first to third variations thereof, a decrease in the efficiency of use of the blue light LB introduced into the light guide 141 can be suppressed, a decrease in the efficiency of use of the green light LG introduced into the light guide 142 can be suppressed, and a decrease in the efficiency of use of the red light LR introduced into the light guide 143 can be suppressed.

In the projector according to the third variation of the present embodiment, when the green and red light outputting sections are configured in the same manner as the blue light outputting section 503, the same advantages and effects provided by the blue light outputting section 503 can be provided by the green and red light outputting sections.

### Fourth Variation

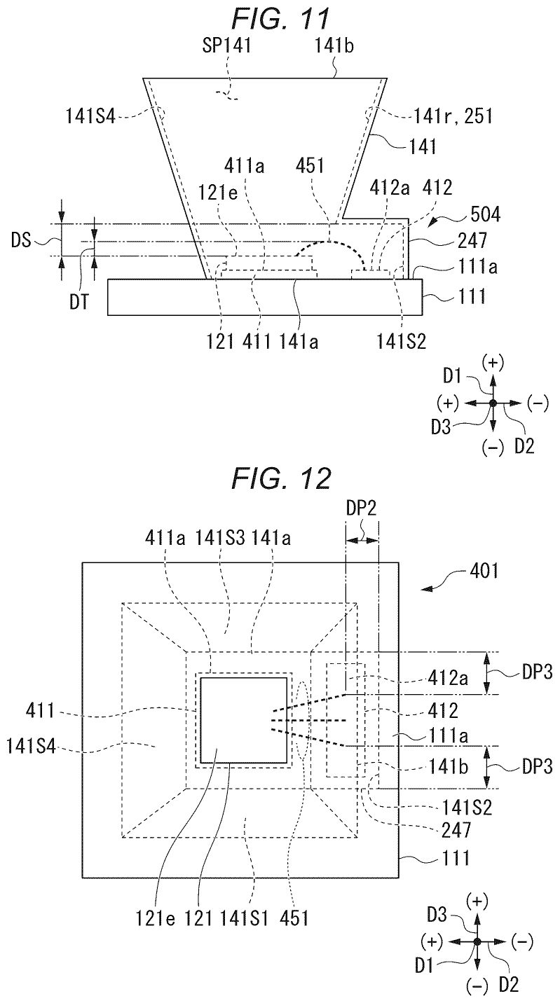

FIG. 11 is a side view of the light source 401 and the light guide 141 of a blue light outputting section 504 according to a fourth variation of the present embodiment, the side view viewed along the D3 direction. FIG. 12 is a plan view of the light source 401 and the light guide 141 of the blue light outputting section 504, the plan view viewed along the D1 direction.

In the blue light outputting section 504, the entire light incident end 141a of the light guide 141 is parallel to the plate surface 111a of the substrate 111 and the light emission surface 121e of the light emitting device 121 in the light source 401, and is parallel to the plane containing the D2 and D3 directions, as shown in FIGS. 11 and 12, as in the blue light outputting section 503. When viewed along the D1 direction, all the electrodes including the electrodes 411 and 412, the light emitting device 121, and the electrically conducting lines 451 are surrounded by the light incident end 141a of the light guide 141.

In the blue light outputting section 504, the light guide 141 tapers from the light exiting end 141b toward the light incident end 141a, and when viewed along the D1 direction, the four side surfaces 141s of the light guide 141 approach the center of the plate surface 111a of the substrate 111 as the light guide 141 extends from the light exiting end 141b toward a predetermined position shifted toward the +D1 side from the light incident end 141a. Irrespective of the relative arrangement of the electrodes 411 and 412 at the plate surface 111a of the substrate 111, out of the four side surfaces 141s of the light guide 141, the angles of the two side surfaces 141s facing each other in the D3 direction with respect to the axis parallel to the D1 direction from the light exiting end 141b to the light incident end 141a are equal to each other.

Out the two side surfaces 141s facing each other in the D2 direction out of the four side surfaces 141s of the light guide 141, the angle of the +D2-side side surface 141s with respect to the axis parallel to the D1 direction from the light exiting end 141b to the light incident end 141a is equal to the angle of the −D2-side side surface 141s with respect to the axis parallel to the D1 direction from the light exiting end 141b to the predetermined position shifted toward the +D1 side from the light incident end 141a. The aforementioned predetermined position shifted from the light incident end 141a in the D1 direction falls within the range of the distance DS from the position of the light emission surface 121e of the light emitting device 121. Out of the two side surfaces 141s facing each other in the D2 direction, the plate-shaped member having the −D2-side side surface 141s has a protrusion 247, which protrudes from the predetermined position toward the −D2 side along the −D2-side portions of the electrically conducting lines 451 and the electrode 412. The reflection surface 141r of the protrusion 247 is shifted toward the +D1 side in the D1 direction by the distance DS away from the light emission surface 121e of the light emitting device 121, and is located at the distance DS from the region occupied by the one or more electrically conducting lines 451 and the electrode 412 in a plane containing the D2 and D3 directions.

The reflection surface 141r of the protrusion 247 of the light guide 141, which faces the electrically conducting lines 451 in the D1 direction, is parallel to the plane containing the D2 and D3 directions. The reflection surface 141r of the protrusion 247, which faces the electrically conducting lines 451 and is shifted toward the −D2 side from the electrically conducting lines 451 in the D2 direction, is parallel to the plane containing the D1 and D3 directions. The reflection surfaces 141r of the protrusion 247, which face the electrically conducting lines 451 and are shifted toward the −D3 and +D3 sides from the electrically conducting lines 451 in the D3 direction, are parallel to the plane containing the D1 and D2 directions. In the blue light outputting section 504, since the light guide 141 includes the protrusion 247 facing the electrically conducting lines 451, disconnection of the electrically conducting lines 451 and a short circuit in the light source 401 are avoided.

The light guide 141 is a hollow member and has a first side surface 141S1, a second side surface 141S2, a third side surface 141S3, and a fourth side surface 141S4, which face the internal space SP141 into which the blue light LB is guided, as shown in FIG. 12. The first side surface 141S1 is configured with a main body and the −D3-side reflection surface 141r out of the reflection surfaces 141r of the protrusion 247, the main body and the protrusion 247 facing each other in the D3 direction, extends along the D2 direction, and reflects the incident blue light LB. The second side surface 141S2 is configured with a −D2-side side surface 247s out of the reflection surfaces 141r that face with each other in the D2 direction, extends along the D3 direction, and reflects the incident blue light LB. The third side surface 141S3 is configured with the +D3-side reflection surface 141r out of the reflection surfaces 141r that face with each other in the D3 direction, extends along the D2 direction, and reflects the incident blue light LB. The fourth side surface 141S4 is configured with the +D2-side reflection surface 141r out of the reflection surfaces 141r that face with each other in the D2 direction, extends along the D3 direction, and reflects the incident blue light LB.

A distance DP3 between the region occupied by the one or more electrically conducting lines 451 and the first side surface 141S1 in the D3 direction is greater than or equal to 0.1 mm but smaller than or equal to 1.0 mm. A distance DP2 between the region occupied by the electrically conducting lines 451 and the second side surface 141S2 in the D2 direction is greater than or equal to 0.1 mm but smaller than or equal to 1.0 mm. Another distance DP3 between the region occupied by the electrically conducting lines 451 and the third side surface 141S3 in the D3 direction is greater than or equal to 0.1 mm but smaller than or equal to 1.0 mm.

The projector according to the fourth variation of the present embodiment described above can provide the same advantages and effects provided by the configurations common to those of the projector according to the present embodiment.

In the projector according to the fourth variation of the present embodiment, in the plan view viewed along the direction in which the blue light LB from the light source 401 exits, that is, the D1 direction, the light incident end 141a of the light guide 141 includes the light emitting device 121 and the electrically conducting lines 451 in the light source 401 and surrounds the light emitting device 121 and the electrically conducting lines 451 in the light source 401.

In the projector according to the fourth variation of the present embodiment, the light incident end 141a of the light guide 141 has a size large enough to surround the light emitting device 121 and the electrically conducting lines 451, so that contact between the electrically conducting lines 451 and the light guide 141 can be avoided even when external impact acts on the projector and the light guide 141 therefore vibrates. The projector according to the fourth variation of the present embodiment can more reliably prevent disconnection of the electrically conducting lines 451 and a short circuit in the light source 401.

In the projector according to the fourth variation of the present embodiment, the internal space SP141 of the light guide 141 tapers from the light exiting end 141b to the predetermined position between the light exiting end 141b and the light incident end 141a in D1 the direction.

In the projector according to the fourth variation of the present embodiment, a decrease in the efficiency of use of the blue light LB introduced into the light guide 141 can be reduced as compared with the decrease in the projector according to the third variation.

In the projector according to the fourth variation of the present embodiment, the light guide 141 has the first side surface 141S1, the second side surface 141S2, the third side surface 141S3, and the fourth side surface 141S4. The first side surface 141S1 extends in parallel to the D2 direction and reflects the incident blue light LB. The second side surface 141S2 is coupled to the first side surface 141S1 at right angles, extends in parallel to the D3 direction, and reflects the incident blue light LB. The third side surface 141S3 is coupled to the second side surface 141S2 at right angles, extends in parallel to the D2 direction, and reflects the incident blue light LB. The fourth side surface 141S4 is coupled to the third side surface 141S3 at right angles, extends in parallel to the D3 direction, and reflects the incident blue light LB. The electrically conducting lines 451 face the first side surface 141S1, the second side surface 141S2, and the third side surface 141S3. The distance DP3 between the electrically conducting lines 451 and the first side surface 141S1 in the D3 direction is greater than or equal to 0.1 mm but smaller than or equal to 1.0 mm. The distance DP2 between the electrically conducting lines 451 and the second side surface 141S2 in the D2 direction is greater than or equal to 0.1 mm but smaller than or equal to 1.0 mm. Another distance DP3 between the region occupied by the electrically conducting lines 451 and the third side surface 141S3 in the D3 direction is greater than or equal to 0.1 mm but smaller than or equal to 1.0 mm.

In the projector according to the fourth variation of the present embodiment, the efficiency of use of the blue light LB output from the light source 401 and introduced into the light guide 141 can be increased, and the reliability of the light source 401 can be improved.

In the projector according to the fourth variation of the present embodiment, when the green and red light outputting sections are configured in the same manner as the blue light outputting section 504, the same advantages and effects provided by the blue light outputting section can be provided by the green and red light outputting sections.

### Fifth Variation

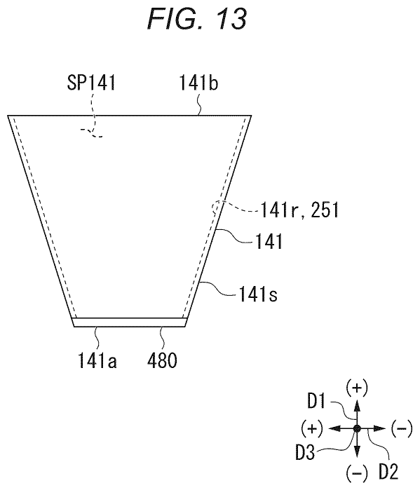

FIG. 13 is a side view of the light guide 141 of a blue light outputting section according to a fifth variation of the present embodiment, the side view viewed along the D3 direction. An insulating layer 480 is provided on the −D1 side of the light incident end 141a of the light guide 141, as shown in FIG. 13. The insulating layer 480 suppresses electrical conduction between the light guide 141 and the electrically conducting lines 451 in the light source 401. The insulating layer 480 may be formed by using a known method to directly perform an insulating treatment on the light incident end 141a, or by attaching a layer or a thin film made of an insulating material such as rubber to the light incident end 141a.

The insulating layer 480 may be provided at the light incident end 141a of the light guide 141, the light incident end 142a of the light guide 142, and the light incident end 143a of the light guide 143 of the projector 301 according to the present embodiment and the projector according to each of the first to fourth variations of the present embodiment.

In the projector according to the fifth variation of the present embodiment, the insulating layer 480 is interposed between the electrically conducting lines 451 and the light guide 141, disconnection of the electrically conducting lines 451 and a short circuit in the light source 401 are more reliably avoided even when external impact acts on the projector.

### Sixth Variation

Although not shown, in a projector according to a sixth variation of the present embodiment, the light guides 141, 142, and 143 are each a solid member, and may be made of a transparent insulating material such as an optical glass. In this case, plate surfaces of the reflectors constituting the light guides 141, 142, and 143 that face the space outside the reflectors, that is, the side surfaces 141s, 142s, and 143s act as the reflection surfaces 141r, 142r, and 143r.

The blue light LB output from the light source 401 enters the reflector constituting the light guide 141 via the light incident end 141a. Part of the blue light LB having entered the light guide 141 is totally reflected off the reflection surfaces 141r facing the space outside the reflector, and travels along the D1 direction and the optical axis. The green light LG output from the light source 402 enters the reflector constituting the light guide 142 via the light incident end 142a. Part of the green light LG having entered the light guide 142 is totally reflected off the reflection surfaces 142r facing the space outside the reflector, and travels along the D2 direction and the optical axis. The red light LR output from the light source 403 enters the reflector constituting the light guide 143 via the light incident end 143a. Part of the red light LR having entered the light guide 143 is totally reflected off the reflection surfaces 143r facing the space outside the reflector, and travels along the D1 direction and the optical axis.

The light guides 141, 142, and 143 may each be a solid element, and may be made of a transparent material such as optical glass, and the reflection films 251, 252, and 253 may be provided at the side surfaces 141s, 142s, and 143s, respectively.

In the projector according to the sixth variation of the present embodiment, the light guides 141, 142, and 143 are made of an insulating material.

The projector according to the sixth variation of the present embodiment allows reduction in losses of the blue light LB, the green light LG, and the red light LR inside the light guides 141, 142, and 143.

A preferable embodiment of the present disclosure has been described above in detail. The present disclosure is, however, not limited to a specific embodiment, and various modifications and changes can be made to the embodiment within the scope of the gist of the present disclosure described in the claims. The configurations of the embodiment and the configurations of the variations may be combined with each other as appropriate.

For example, the projector according to the present embodiment may be what is called a single-plate projector. In this case, the light emitting device (first light emitting device) of the light source (first light source) may emit visible-wavelength-band white light containing the blue light LB, the green light LG, and the red light LR, and may be configured, for example, with a white LED.

### SUMMARY OF PRESENT DISCLOSURE

The present disclosure will be summarized below as additional remarks.

(Additional Remark 1) A projector including: a first light source including a first light emitting device configured to emit first light having a first wavelength band, a first electrically conducting line configured to supply the first light emitting device with electric power, and a base configured to support the first light emitting device and the first electrically conducting line; a first light guide having a first light incident end on which the first light output from the first light source is incident and a first light exiting end via which the first light exits, the first light guide configured to homogenize in-plane illuminance of the first light; a first parallelizing element configured to parallelize the first light output from the first light guide; a first light modulator configured to modulate the first light output from the first parallelizing element based on image information; and a projection system configured to project the light modulated by the first light modulator, wherein the first light guide is disposed away from the first electrically conducting line, and a first distance between the first light incident end of the first light guide and the first light source is smaller than or equal to 0.7 mm.

According to the configuration described in Additional Remark 1, disconnection of the first electrically conducting line and a short circuit in the first light source can be avoided with a decrease in efficiency of use of the color light suppressed.

(Additional remark 2) The projector according to Additional remark 1, wherein the first light guide has a quadrangular cross-sectional shape.

According to the configuration described in Additional Remark 2, quadrangular illumination light having a homogenized illuminance distribution can be readily generated.

(Additional Remark 3) The projector according to Additional remark 1 or 2, wherein the first light guide is in contact with the first light source.

According to the configuration described in Additional Remark 3, the efficiency at which the first light is introduced into the first light guide can be increased.

(Additional Remark 4) The projector according to any one of Additional Remarks 1 to 3, wherein a cutout is formed in the first light guide at a position where the cutout faces the first electrically conducting line, and the first electrically conducting line is inserted into the first light incident end through the cutout from a side outside the first light incident end.

According to the configuration described in Additional Remark 4, the cutout can avoid contact between the first light guide and the first electrically conducting line, minimize a decrease in the area of the first light emitting device, and increase the efficiency of use of the first light.

(Additional Remark 5) The projector according to Additional Remark 4, wherein a dimension of the cutout in a direction in which the first light from the first light source exits is greater than or equal to 0.1 mm but smaller than or equal to 0.7 mm.

According to the configuration described in Additional Remark 5, to avoid contact between the first light guide and the first electrically conducting line, the size of the cutout is minimized and the loss of the first light can be minimized.

(Additional Remark 6) The projector according to any one of Additional Remarks 1 to 5, wherein the base includes a sealing member configured to cover the first electrically conducting line, the sealing member is an insulating member, and the first light incident end is in contact with the sealing member.

According to the configuration described in Additional Remark 6, since the sealing member, which is an insulating member, is interposed between the first light guide and the first light source, the efficiency of use of the first light can be increased with disconnection of the first electrically conducting line avoided.

(Additional Remark 7) The projector according to any one of Additional Remarks 1 to 6, wherein the first light source includes a light divergence section disposed on a light exiting side of the first light emitting device via which the first light exits and configured to cause the first light to diverge, and the sealing member is configured to support a circumference of the first light emitting device and the light divergence section.

According to the configuration described in Additional Remark 7, the configuration of the light divergence section can be simplified, and the durability of the first light emitting device can be enhanced. Furthermore, according to the configuration described in Additional Remark 7, since the light emission surface of the first light emitting device approaches the first light incident end of the first light guide, the efficiency at which the first light is introduced and used can be increased.

(Additional Remark 8) The projector according to any one of Additional Remarks 1 to 7, wherein in a plan view viewed along a direction in which the first light from the first light source exits, the first light incident end surrounds the first light emitting device and the first electrically conducting line.

According to the configuration described in Additional Remark 8, the first light incident end is large enough to surround the first light emitting device and the first electrically conducting line, so that contact between the first light guide and the first electrically conducting line can be avoided even when external impact acts on the projector and the first light guide therefore vibrates.

(Additional Remark 9) The projector according to Additional Remark 8, wherein the first light guide is a hollow member, and an internal space of the first light guide tapers from the first light exiting end to a position between the first light exiting end and the first light incident end.

According to the configuration described in Additional Remark 9, loss of the first light output from the first light guide can be reduced.

(Additional Remark 10) The projector according to Additional Remark 8 or 9, wherein the first light guide has a first side surface configured to reflect the first light, a second side surface coupled to the first side surface at right angles and configured to reflect the first light, a third side surface coupled to the second side surface at right angles and configured to reflect the first light, and a fourth side surface coupled to the third side surface at right angles and configured to reflect the first light, the first electrically conducting line faces the first, second, and the third side surfaces, a distance between the first electrically conducting line and the first side surface is greater than or equal to 0.1 mm but smaller than or equal to 1.0 mm, a distance between the first electrically conducting line and the second side surface is greater than or equal to 0.1 mm but smaller than or equal to 1.0 mm, and a distance between the first electrically conducting line and the third side surface is greater than or equal to 0.1 mm but smaller than or equal to 1.0 mm.

According to the configuration described in Additional Remark 10, the efficiency of use of the first light and the reliability of the first light source can be increased.

(Additional Remark 11) The projector according to any one of Additional Remarks 1 to 10, wherein the first light guide includes an insulating layer configured to suppress electrical conduction between the first light guide and the first electrically conducting line, the insulating layer provides at the first light incident end.

According to the configuration described in Additional Remark 11, the insulating layer is interposed between the first light guide and the first electrically conducting line, disconnection of the first electrically conducting line and a short circuit in the first light source are reliably avoided even when external impact acts on the projector.

(Additional Remark 12) The projector according to any one of Additional Remarks 1 to 11, wherein the first light guide is made of an insulating material.

According to the configuration described in Additional Remark 12, even when external impact acts on the projector so that the first light guide and the first electrically conducting line come into contact with each other, a short circuit in the first light source can be reliably avoided.

(Additional Remark 13) The projector according to any one of Additional Remarks 1 to 12, further including: a second light source including a second light emitting device configured to emit second light having a second wavelength band, a second electrically conducting line configured to supply the second light emitting device with electric power, and a base configured to support the second light emitting device and the second electrically conducting line; a third light source including a third light emitting device configured to emit third light having a third wavelength band, a third electrically conducting line configured to supply the third light emitting device with electric power, and a base configured to support the third light emitting device and the third electrically conducting line; a second light guide having a second light incident end on which the second light output from the second light source is incident and a second light exiting end via which the second light exits, the second light guide configured to homogenize in-plane illuminance of the second light; a third light guide having a third light incident end on which the third light output from the third light source is incident and a third light exiting end via which the third light exits, the third light guide configured to homogenize in-plane illuminance of the third light; a second parallelizing element configured to parallelize the second light output from the second light guide; a third parallelizing element configured to parallelizes the third light output from the third light guide; a second light modulator configured to modulate the second light output from the second parallelizing element based on image information; and a third light modulator configured to modulate the third light output from the third parallelizing element based on image information, wherein the second light guide is disposed away from the second electrically conducting line, the third light guide is disposed away from the third electrically conducting line, a second distance between the second light incident end of the second light guide and the second light source is smaller than or equal to 0.7 mm, and a third distance between the third light incident end of the third light guide and the third light source is smaller than or equal to 0.7 mm.

According to the configuration described in Additional Remark 13, disconnection of the first electrically conducting line and a short circuit in the first light source can be avoided with a decrease in efficiency of use of the color light suppressed.

What is claimed is:

1. A projector comprising:
a first light source including a first light emitting device configured to emit first light having a first wavelength band, a first electrically conducting line configured to supply the first light emitting device with electric power, and a base configured to support the first light emitting device and the first electrically conducting line;
a first light guide having a first light incident end on which the first light output from the first light source is incident and a first light exiting end via which the first light exits, the first light guide configured to homogenize in-plane illuminance of the first light;
a first parallelizing element configured to parallelize the first light output from the first light guide;
a first light modulator configured to modulate the first light output from the first parallelizing element based on image information; and
a projection system configured to project the light modulated by the first light modulator,
wherein the first light guide is disposed away from the first electrically conducting line, and
a first distance between the first light incident end of the first light guide and the first light source is smaller than or equal to 0.7 mm.

2. The projector according to claim 1, wherein
the first light guide has a quadrangular cross-sectional shape.

3. The projector according to claim 1, wherein
the first light guide is in contact with the first light source.

4. The projector according to claim 1, wherein
a cutout is formed in the first light guide at a position where the cutout faces the first electrically conducting line, and
the first electrically conducting line is inserted into the first light incident end through the cutout from a side outside the first light incident end.

5. The projector according to claim 4, wherein
a dimension of the cutout in a direction in which the first light from the first light source exits is greater than or equal to 0.1 mm but smaller than or equal to 0.7 mm.

6. The projector according to claim 1, wherein
the base includes a sealing member configured to cover the first electrically conducting line,
the sealing member is an insulating member, and
the first light incident end is in contact with the sealing member.

7. The projector according to claim 6, wherein
the first light source includes a light divergence section disposed on a light exiting side of the first light emitting device via which the first light exits and configured to cause the first light to diverge, and
the sealing member is configured to support a circumference of the first light emitting device and the light divergence section.

8. The projector according to claim 1, wherein
in a plan view viewed along a direction in which the first light from the first light source exits, the first light incident end surrounds the first light emitting device and the first electrically conducting line.

9. The projector according to claim 8, wherein
the first light guide is a hollow member, and
an internal space of the first light guide tapers from the first light exiting end to a position between the first light exiting end and the first light incident end.

10. The projector according to claim 8, wherein
the first light guide has
a first side surface configured to reflect the first light,
a second side surface coupled to the first side surface at right angles and configured to reflect the first light,
a third side surface coupled to the second side surface at right angles and configured to reflect the first light, and
a fourth side surface coupled to the third side surface at right angles and configured to reflect the first light,
the first electrically conducting line faces the first, second, and the third side surfaces,
a distance between the first electrically conducting line and the first side surface is greater than or equal to 0.1 mm but smaller than or equal to 1.0 mm,
a distance between the first electrically conducting line and the second side surface is greater than or equal to 0.1 mm but smaller than or equal to 1.0 mm, and
a distance between the first electrically conducting line and the third side surface is greater than or equal to 0.1 mm but smaller than or equal to 1.0 mm.

11. The projector according to claim 1, wherein
the first light guide includes an insulating layer configured to suppress electrical conduction between the first light guide and the first electrically conducting line, the insulating layer provides at the first light incident end.

12. The projector according to claim 1, wherein
the first light guide is made of an insulating material.

13. The projector according to claim 1, further comprising:
a second light source including a second light emitting device configured to emit second light having a second wavelength band, a second electrically conducting line configured to supply the second light emitting device with electric power, and a base configured to support the second light emitting device and the second electrically conducting line;
a third light source including a third light emitting device configured to emit third light having a third wavelength band, a third electrically conducting line configured to supply the third light emitting device with electric power, and a base configured to support the third light emitting device and the third electrically conducting line;
a second light guide having a second light incident end on which the second light output from the second light source is incident and a second light exiting end via which the second light exits, the second light guide configured to homogenize in-plane illuminance of the second light;
a third light guide having a third light incident end on which the third light output from the third light source is incident and a third light exiting end via which the third light exits, the third light guide configured to homogenize in-plane illuminance of the third light;
a second parallelizing element configured to parallelize the second light output from the second light guide;
a third parallelizing element configured to parallelize the third light output from the third light guide;
a second light modulator configured to modulate the second light output from the second parallelizing element based on image information; and
a third light modulator configured to modulate the third light output from the third parallelizing element based on image information,
wherein the second light guide is disposed away from the second electrically conducting line,
the third light guide is disposed away from the third electrically conducting line,
a second distance between the second light incident end of the second light guide and the second light source is smaller than or equal to 0.7 mm, and
a third distance between the third light incident end of the third light guide and the third light source is smaller than or equal to 0.7 mm.
